(19) United States
(12) Patent Application Publication
(10) Pub. No.: US 2026/0290192 A1
(43) Pub. Date: Sep. 24, 2026

(54) SYSTEM

(71) Applicant: SoftBank Group Corp., Tokyo (JP)

(72) Inventor: Tsuyoshi OKAMOTO, Tokyo (JP)

(73) Assignee: SoftBank Group Corp., Tokyo (JP)

(21) Appl. No.: 19/565,567

(22) Filed: Mar. 13, 2026

(30) Foreign Application Priority Data
Mar. 19, 2025 (JP) 2025-045051

(51) Int. Cl. G09B 7/04; G06F 40/253; G06F 40/284; G06F 40/289; G06F 40/30; G06F 40/40; G10L 13/027

(52) U.S. Cl. CPC G09B 7/04; G06F 40/253; G06F 40/284; G06F 40/289; G06F 40/30; G06F 40/40; G10L 13/027

(57) ABSTRACT

A system includes a processor that is configured to analyze content of a textbook by using a natural language processing engine, extract important information from the textbook content, and generate a summary of the textbook content based on the important information, provide a prompt sentence to a generative artificial intelligence model so as to cause the generative artificial intelligence model to generate an appropriate answer to a question from a student, and analyze an emotion of the student by using an emotion recognition engine and provide feedback corresponding to the emotion of the student.

### CROSS-REFERENCE TO RELATED APPLICATION

This application is based on and claims priority under 35 USC 119 from Japanese Patent Application No. 2025-045051 filed on Mar. 19, 2025, the disclosure of which is incorporated by reference herein.

### BACKGROUND

### Technical Field

The present disclosure relates to a system.

### Related Art

Japanese Patent Application Laid-Open (JP-A) No. 2022-180282 discloses a persona chatbot control method executed by at least one processor. The method includes steps of: receiving a user utterance, adding the user utterance to a prompt including a description of a chatbot character and an associated instruction sentence, encoding the prompt, and inputting the encoded prompt to a language model to generate a chatbot utterance responding to the user utterance.

Conventional computer-assisted learning systems mainly present static digital content such as electronic textbooks and prerecorded videos, and therefore cannot flexibly adapt to individual students in real time. In particular, such systems have the following problems. First, conventional systems do not automatically analyze textbook content to extract important information and generate concise summaries suited to a specific lesson or student level, and teachers or content creators must manually prepare summarized learning materials, which is time-consuming and not scalable. Second, when a student asks a question, conventional systems either provide only predefined frequently asked questions and answers, or rely on human teachers to respond, and therefore cannot generate appropriate, context-aware answers that reflect both the textbook content and the specific question of the student on demand. Third, conventional systems do not recognize the emotional state of the student during learning, and thus cannot adjust feedback or guidance according to whether the student is, for example, confused, bored, anxious, or confident. As a result, it is difficult to maintain motivation and to provide timely support tailored to the student's emotional condition. Accordingly, there is a need for a system that automatically analyzes textbook content using a natural language processing engine, that generates suitable answers to student questions by using a generative artificial intelligence model, and that analyzes the emotion of the student and provides feedback corresponding to the emotion, so as to realize highly personalized and responsive learning support.

### SUMMARY

In order to solve the above-described problems, an embodiment of the present invention provides a system comprising a processor, wherein the processor is configured to analyze content of a textbook by using a natural language processing engine, extract important information from the textbook content, and generate a summary of the textbook content based on the important information. In the embodiment, the processor is configured to provide, to a generative artificial intelligence model, a prompt for instructing the generative artificial intelligence model to understand the content of the textbook when generating the summary of the textbook content, and to generate the summary based on a result of processing performed by the generative artificial intelligence model in response to the prompt. The processor is further configured to provide a prompt sentence to the generative artificial intelligence model so as to cause the generative artificial intelligence model to generate an appropriate answer to a question from a student, and, when generating the answer to the question, to provide, to the generative artificial intelligence model, a prompt for instructing the generative artificial intelligence model to understand content of the question from the student and to generate the answer based on a result of processing performed by the generative artificial intelligence model in response to the prompt. In addition, the processor is configured to analyze an emotion of the student by using an emotion recognition engine and to provide feedback corresponding to the emotion of the student. By combining the textbook analysis and summarization by the natural language processing engine, the answer generation by the generative artificial intelligence model based on appropriate prompts, and the emotion analysis and feedback by the emotion recognition engine, the embodiment enables automatic generation of personalized summaries, context-aware answers, and emotion-sensitive feedback, thereby solving the above-mentioned problems of conventional learning systems.

The term “processor” refers to one or more hardware processing units, such as a central processing unit (CPU), a graphics processing unit (GPU), a digital signal processor (DSP), or any combination thereof, that executes instructions to perform the functions described in the present specification.

The term “natural language processing engine” refers to a software component or service that processes natural language text, including at least one of analyzing syntax or semantics, extracting information, and transforming or summarizing text, on the basis of machine learning or rule-based techniques.

The term “textbook” refers to digital instructional material, including electronic documents, files, or data representing educational content for a particular subject or grade, that is used as a primary source of learning content for a student.

The term “content of a textbook” refers to text, and optionally figures, tables, or embedded metadata extracted from a textbook, that is subject to analysis, summarization, or other processing by the system.

The term “important information” refers to information that is determined, by the natural language processing engine or by processing performed by the processor, to be central or relevant to understanding the textbook content, including at least one of key concepts, definitions, main ideas, example problems, and learning objectives.

The term “summary of the textbook content” refers to text generated by the system that represents a condensed version of the content of a textbook, in which the important information is expressed in a shorter and more easily understandable form than the original textbook content.

The term “generative artificial intelligence model” refers to a machine learning model that generates new outputs, such as natural language text, in response to input data, and that is trained using at least one of neural network techniques, deep learning, or large language model architectures.

The term “prompt” refers to information provided as input to the generative artificial intelligence model, including at least one of instructions, examples, or context text, that conditions or guides the behavior of the generative artificial intelligence model when generating an output.

The term “prompt sentence” refers to a specific type of prompt that is expressed as one or more sentences in natural language and that instructs the generative artificial intelligence model how to process given input content or how to generate an output.

The term “question from a student” refers to natural language input representing an inquiry, request for explanation, or clarification submitted by a user who is learning using the system. The term “appropriate answer” refers to an output generated by the generative artificial intelligence model that responds to a question from a student in a manner that is contextually relevant, factually consistent with the textbook content or other reference data, and suitable for the student's intended educational level.

The term “emotion recognition engine” refers to a software component or service that estimates an emotional state of a student by analyzing input data, including at least one of voice data, facial images, text input, behavioral logs, or physiological signals, using machine learning, pattern recognition, or rule-based techniques.

The term “emotion of the student” refers to at least one of emotional states, such as interest, confusion, frustration, boredom, anxiety, satisfaction, or confidence, that is inferred by the emotion recognition engine based on data related to the student.

The term “feedback corresponding to the emotion of the student” refers to information or guidance generated by the system, including at least one of messages, hints, encouragement, or adjustments of content difficulty, that is selected or adapted according to the emotion of the student as recognized by the emotion recognition engine.

### BRIEF DESCRIPTION OF THE DRAWINGS

Exemplary embodiments of the present disclosure will be described in detail based on the following figures, wherein:

FIG. 1 is a schematic diagram illustrating an example of a configuration of a data processing system according to a first exemplary embodiment;

FIG. 2 is a schematic diagram illustrating an example of relevant functions of a data processing device and a smart device according to the first exemplary embodiment;

FIG. 3 is a schematic diagram illustrating an example of a configuration of a data processing system according to a second exemplary embodiment;

FIG. 4 is a schematic diagram illustrating an example of relevant functions of a data processing device and smart glasses according to the second exemplary embodiment;

FIG. 5 is a schematic diagram illustrating an example of a configuration of a data processing system according to a third exemplary embodiment;

FIG. 6 is a schematic diagram illustrating an example of relevant functions of a data processing device and a headset-type terminal according to the third exemplary embodiment;

FIG. 7 is a schematic diagram illustrating an example of a configuration of a data processing system according to a fourth exemplary embodiment;

FIG. 8 is a schematic diagram illustrating an example of relevant functions of a data processing device and a robot according to the fourth exemplary embodiment;

FIG. 9 illustrates an emotion map mapping plural emotions;

FIG. 10 illustrates an emotion map mapping plural emotions;

FIG. 11 is a sequence diagram showing the flow of data processing system processing in Example 1;

FIG. 12 is a sequence diagram showing the flow of data processing system processing in Application Example 1;

FIG. 13 is a sequence diagram showing the flow of data processing system processing in Example 2; and

FIG. 14 is a sequence diagram showing the flow of data processing system processing in Application Example 2.

### DETAILED DESCRIPTION

Description follows regarding an example of exemplary embodiments of a system according to technology disclosed herein, with reference to the appended drawings.

First, explanation follows regarding terminology employed in the following description.

In the following exemplary embodiments, a reference-numeral-appended processor (hereinafter simply referred to as “processor”) may be implemented by a single computation unit, and may be implemented by a combination of plural computation units. The processor may be implemented by a single type of computation unit, or may be implemented by a combination of plural types of computation units. Examples of computation unit include a central processing unit (CPU), a graphics processing unit (GPU), a general-purpose computing on graphics processing units (GPGPU), an accelerated processing unit (APU), and the like.

In the following exemplary embodiments, random access memory (RAM) appended with a reference numeral is memory temporarily stored with information, and is employed as working memory by a processor.

In the following exemplary embodiments, reference-numeral-appended storage is a single or plural non-volatile storage devices for storing various programs and various parameters and the like. Examples of non-volatile storage devices include flash memory (such as a solid state drive (SSD)), a magnetic disk (for example, a hard disk), magnetic tape, and the like.

In the following exemplary embodiments, a reference-numeral-appended communication interface (I/F) is an interface including a communication processor and an antenna or the like. The communication I/F has the role of communicating between plural computers. An example of a communication standard applied for the communication I/F is a wireless communication standard, such as a Fifth Generation Mobile Communication System (5G), Wi-Fi (registered trademark), Bluetooth (registered trademark), and the like.

In the following exemplary embodiments “A and/or B” has the same definition as “at least one out of A or B”. Namely, “A and/or B” may mean A alone, may mean B alone, or may mean a combination of A and B. Moreover, similar logic to “A and/or B” is applied when “and/or” is employed to link three or more items in the present specification.

### First Exemplary Embodiment

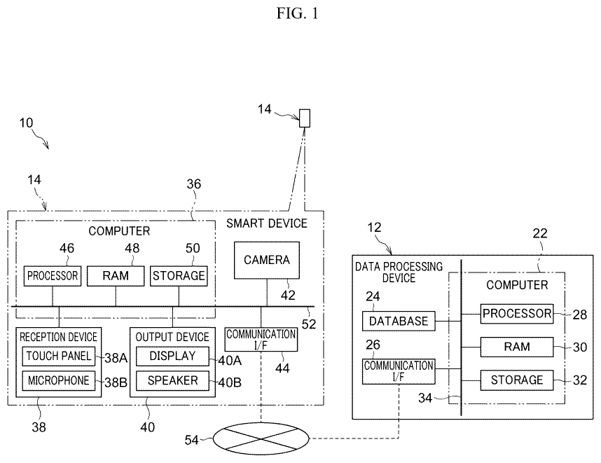

FIG. 1 illustrates an example of a configuration of a data processing system 10 according to a first exemplary embodiment.

As illustrated in FIG. 1, the data processing system 10 includes a data processing device 12 and a smart device 14. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart device 14 includes a computer 36, a reception device 38, an output device 40, a camera 42, and a communication I/F 44. The computer 36 includes a processor 46, RAM 48, and storage 50. The processor 46, the RAM 48, and the storage 50 are connected to a bus 52. The reception device 38, the output device 40, the camera 42, and the communication I/F 44 are also connected to the bus 52.

The reception device 38 includes a touch panel 38A, a microphone 38B, and the like for receiving user input. The touch panel 38A receives user input from contact of a pointer (for example, a pen, a finger, or the like) by detecting contact of the pointer. The microphone 38B receives spoken user input by detecting speech of the user. A control unit 46A in the processor 46 transmits data representing the user input received by the touch panel 38A and the microphone 38B to the data processing device 12. A specific processing unit 290 in the data processing device 12 acquires the data indicating the user input.

The output device 40 includes a display 40A, a speaker 40B, and the like for presenting data to a user 20 by outputting the data in an expression format perceivable by the user 20 (for example, audio and/or text). The display 40A displays visual information such as text, images, or the like under instruction from the processor 46. The speaker 40B outputs audio under instruction from the processor 46. The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like.

The communication I/F 44 is connected to the network 54. The communication I/F 44 and the communication I/F 26 perform the role of exchanging various information between the processor 46 and the processor 28 over the network 54.

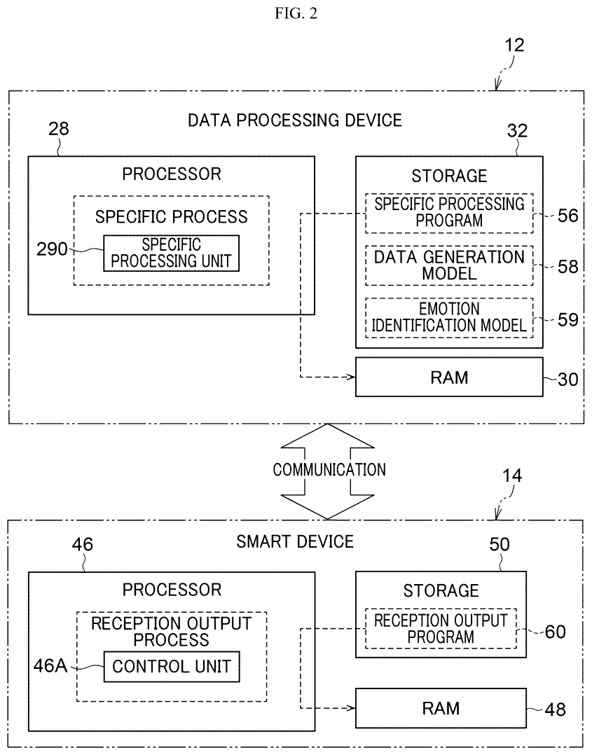

FIG. 2 illustrates an example of relevant functions of the data processing device 12 and the smart device 14.

As illustrated in FIG. 2, specific processing is performed by the processor 28 in the data processing device 12. A specific processing program 56 is stored in the storage 32. The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

A data generation model 58 and an emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart device 14. A reception and output program 60 is stored in the storage 50. The reception and output program 60 is employed by the data processing system 10 in combination with the specific processing program 56. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48. Note that a configuration may be adopted in which a similar data generation model and emotion identification model to the data generation model 58 and the emotion identification model 59 are included in the smart device 14, and these models are used to perform similar processing to the specific processing unit 290. The reception and output program is implemented by the processor 46 operating as the control unit 46A according to the reception and output program 60 executed in the RAM 48.

Note that devices other than the data processing device 12 may include the data generation model 58. For example, a server device (for example, a generation server) may include the data generation model 58. In such cases, the data processing device 12 performs communication with the server device including the data generation model 58 to obtain a processing result (prediction result or the like) obtained using the data generation model 58. The data processing device 12 may be a server device, and may be a terminal device owned by the user (for example, a mobile phone, a robot, a home electrical appliance, or the like). Next, description follows regarding an example of processing by the data processing system 10 according to the first exemplary embodiment.

### Example 1

Description follows regarding a flow of the specific processing in an Example 1. The units of the system described below are implemented by the data processing device 12 and the smart device 14. The data processing device 12 is called a “server” and the smart device 14 is called a “terminal”.

Conventional computer-implemented educational support systems typically handle summarization of educational documents, response generation to learner questions, and assignment creation as separate, loosely coupled functions. In many architectures, a summarization engine processes textbook data in isolation, a question-answering engine responds to learner queries without consistent grounding in the same summarized or original content, and an assessment engine generates and grades assignments using predefined templates. As a result, such systems often rely on hand-crafted rules, fixed domain models, or manually curated content mappings, which limit scalability and adaptability.

Further, in conventional systems that incorporate generative models, the models are often invoked with ad hoc textual prompts directly reflecting the user's query or static instructions. The systems do not systematically construct structured input sequences that combine document-derived importance information, time-based educational segmentation, learner state information, and explicit learning objectives. This leads to inefficient use of computational resources, because the generative model repeatedly re-processes long, unstructured document text, and also leads to unstable output quality, because the model is not consistently guided by explicit, machine-constructed prompt sequences tailored to the downstream task.

Moreover, known systems typically do not provide an integrated mechanism by which a processor coordinates: (i) extraction of high-importance information from document data using a natural language processing engine, (ii) time-unit-based summarization optimized for presentation in instructional segments, (iii) context-aware response generation constrained by both the original document and the generated summaries, and (iv) automatic generation and grading of evaluation assignments using the same generative engine. This lack of coordination produces redundant computations across components, inconsistent use of context, and fragmented user experiences.

From the standpoint of computer technology, there is therefore a need for an improved system architecture and data processing method in which a processor programmatically constructs structured data representations and input sequences for a generative AI model, reuses document analysis results across multiple tasks, and coordinates summarization, question answering, and assignment generation within a unified pipeline. Such an architecture should reduce repeated parsing and processing of the same document data, improve the efficiency and determinism of model invocation, and provide a technically improved way of guiding the generative AI model by dynamically generated prompt sentences that incorporate summarized context, learning objectives, and learner state information. The technical problem addressed by the present invention is to provide such an integrated, computer-implemented mechanism that improves the operation of the computing system itself when performing educational content processing, rather than merely automating a human teaching workflow.

The specific processing by the specific processing unit 290 of the data processing device 12 in Example 1 is realized by the following means.

The present invention provides a server comprising a processor configured to receive document data and a prompt sentence from a terminal, convert the document data and the prompt sentence into structured data, store the structured data, preprocess the document data and the prompt sentence to convert them into token sequences, and generate an input sequence for operating a natural language processing engine and a generative AI model based on the token sequences; apply the natural language processing engine to the input sequence to extract high-importance information from the document data and specify summarization target information based on the extracted high-importance information; provide an input sequence including the summarization target information and the prompt sentence to the generative AI model as a prompt sentence and cause the generative AI model to generate summary text segmented in educational time units; provide, to the generative AI model as a prompt sentence, an input sequence including question content from a learner and at least one of the document data and the summary text and cause the generative AI model to generate response text corresponding to the question content; provide, to the generative AI model as a prompt sentence, the document data and a prompt sentence relating to a learning objective and cause the generative AI model to generate evaluation assignment data based on the document data; receive answer data for the evaluation assignment data from the learner and generate automatic scoring data and evaluation result data based on the evaluation assignment data and the answer data; and generate feedback information based on the evaluation result data and learner state information, and transmit the summary text, the response text, the evaluation assignment data, and the feedback information to the terminal. This enables an integrated and technically improved processing pipeline in which the server reuses structured representations and extracted importance information to guide the generative AI model across multiple tasks, reduces redundant computation on the same document data, and systematically constructs machine-generated prompt sentences and input sequences that optimize the operation of the natural language processing engine and the generative AI model for summarization, question answering, and assignment generation and grading within a unified computer system.

The term “document data” refers to electronic text data representing content of educational material, including but not limited to textbooks, reference materials, lecture notes, and other instructional documents, which are stored and processed in a machine-readable format.

The term “prompt sentence” refers to machine-processed textual instruction data that is supplied to a generative AI model or a natural language processing engine in order to specify a task, such as summarization, question answering, assignment generation, or evaluation, and to control the behavior of the model.

The term “terminal” refers to an information processing device operated by a learner or another user, including but not limited to a mobile device, a tablet device, a personal computer, or a web client, that transmits input data to a server and receives and displays output data from the server.

The term “structured data” refers to data that has been converted from raw input form into an organized representation, such as records, fields, identifiers, or tagged elements, suitable for processing and storage by a computing system.

The term “token sequence” refers to an ordered list of discrete elements obtained by segmenting text data into units such as subword units, words, or symbols, which are used as input to a natural language processing engine or a generative AI model.

The term “input sequence” refers to a structured arrangement of one or more token sequences, optionally including control tokens and metadata, that is supplied to a natural language processing engine or a generative AI model for inference.

The term “natural language processing engine” refers to software-implemented functionality executed by a processor to analyze natural language text, including but not limited to parsing, feature extraction, semantic analysis, and importance estimation, in order to generate intermediate representations used by other components.

The term “generative AI model” refers to a parameterized machine learning model, such as a neural network-based language model, configured to generate text data in response to an input sequence and a prompt sentence, by outputting token sequences that represent natural language content.

The term “high-importance information” refers to portions of document data, such as sentences, phrases, or concepts, that are determined by the natural language processing engine to be more relevant or significant with respect to a given task, such as summarization or question answering.

The term “summarization target information” refers to selected high-importance information and associated context that has been identified as the basis for generating a condensed representation of the document data.

The term “summary text” refers to text data generated by the generative AI model that provides a condensed representation of the document data by expressing, in reduced length, the main points or essential information contained in the document data.

The term “educational time unit” refers to a predefined temporal segment used for presenting educational content, such as a lesson block or a time slot suitable for instruction, which is used to segment summary text and other content for time-based delivery.

The term “learner” refers to a user of the system who receives educational content, submits questions, answers assignments, and obtains feedback, including but not limited to a student or a trainee.

The term “question content” refers to text data that represents an inquiry from a learner, including interrogative sentences or other natural language expressions requesting clarification, explanation, or additional information.

The term “response text” refers to text data generated by the generative AI model that is intended to answer or address question content submitted by a learner.

The term “learning objective” refers to information indicating a target concept, skill, topic, or competency that the educational content, assignments, and feedback are designed to address.

The term “evaluation assignment data” refers to structured data representing one or more assessment items generated based on document data and a learning objective, including but not limited to questions, answer formats, correct answers, and scoring criteria.

The term “answer data” refers to data representing a learner's responses to evaluation assignment data, including selected options, numeric values, or free-text answers entered via a terminal.

The term “automatic scoring data” refers to data representing machine-generated scoring results for answer data with respect to evaluation assignment data, including but not limited to raw scores, partial credits, or correctness indicators, produced without manual grading.

The term “evaluation result data” refers to structured data summarizing the outcome of assessing answer data against evaluation assignment data, including scores, performance metrics, and per-item evaluation information.

The term “learner state information” refers to data representing a status or profile of a learner within the system, including but not limited to progress, historical performance, difficulty preferences, and prior interactions, which is used to tailor feedback.

The term “feedback information” refers to text data and associated metadata generated based on evaluation result data and learner state information, which provide the learner with explanations, guidance, or recommendations regarding learning performance and next actions.

In one embodiment, a server, a terminal, and a user cooperate to implement the claimed system by means of specific hardware resources, software modules, and data structures.

The server uses a hardware configuration that includes at least one central processing unit (CPU), a main memory (RAM), a nonvolatile storage device such as a solid-state drive, and a network interface. The server optionally uses a graphics processing unit (GPU) that supports general-purpose computation. The server executes a server operating system such as a general-purpose server operating system, a web server program, and an application framework implemented in a general-purpose programming language. The server further executes a natural language processing engine and at least one generative AI model implemented on a machine learning framework such as a tensor computation framework. The server stores model parameters, tokenizers, and configuration data in the nonvolatile storage device and loads them into the main memory and GPU memory during operation.

The terminal uses a hardware configuration that includes a processor, a memory, an input device such as a touchscreen or keyboard, and a display device. The terminal executes a client operating system, and either a web browser or a dedicated learning application. The terminal communicates with the server via a network using a secure transport protocol.

The user operates the terminal to provide document data and a prompt sentence to the server. The user, for example, selects a digital textbook chapter on the terminal and inputs a prompt sentence such as “Please summarize the causes and consequences of World War II in a way suitable for a 15-minute class segment.” The user may further input a question as a prompt sentence such as “Why did the Treaty of Versailles contribute to the outbreak of World War II? Explain briefly.” The user may also answer automatically generated assignments by selecting options or entering free-text answers on the terminal.

The server uses the natural language processing engine to transform the raw document data and prompt sentences into structured data. The server stores, for each session, a record including a document identifier, a learner identifier, a set of text segments, and metadata such as section boundaries and timestamps. The server maintains token sequences for document data and for each prompt sentence. The server constructs an input sequence as a concatenation of tokens representing an instruction, the prompt sentence, and the relevant document data, together with additional control tokens that indicate structural boundaries such as “Instruction:”, “Document:”, “Summary:”, “Question:”, and “Answer:”. These control tokens act as explicit markers that guide the generative AI model's attention and output behavior.

The server uses a generative AI model in the form of a neural network, for example a transformer-based language model. The generative AI model includes multiple stacked self-attention layers, feedforward layers, and normalization layers. The model uses an embedding layer that converts token IDs into continuous vectors, a positional encoding mechanism that injects sequence order information, and a sequence of transformer blocks. Each transformer block includes a multi-head self-attention module that computes attention weights over all tokens in the sequence, followed by a feedforward network that applies nonlinear transformations. The server stores the model's parameters, such as weight matrices and bias vectors, as multidimensional tensors. During operation, the server performs floating-point matrix multiplications, additions, and activation function evaluations on the CPU and, when available, on the GPU.

The server uses the natural language processing engine to compute, for each sentence in the document data, numerical feature vectors that represent semantic content, such as sentence embeddings. The server calculates sentence importance scores by applying operations such as cosine similarity between sentence embeddings and a prompt embedding, by applying learned linear layers, or by aggregating attention weights from the generative AI model. The server selects high-importance information by choosing sentences with scores above a threshold or by performing top-k selection. The server stores sentence indices and scores in a data structure such as a table indexed by document identifier and session identifier. The server determines summarization target information by combining the selected sentences and associated context, such as neighboring sentences that provide necessary background. The server represents the summarization target information as an ordered list of text segments and corresponding token indices. By constructing this explicit target representation, the server reduces the amount of text the generative AI model must process to generate a summary, thereby decreasing computational cost and memory usage relative to processing the entire raw document repeatedly.

The server constructs a prompt sentence for summarization that explicitly instructs the generative AI model to understand the document data and to produce output segmented by educational time units. For example, the server may construct an internal prompt sentence such as “Understand the following textbook passage and generate a summary that can be presented in three 15-minute lessons.” The server appends the selected summarization target information after this instruction. The server then feeds the combined input sequence into the generative AI model.

The server causes the generative AI model to generate summary text by performing autoregressive decoding. The server uses algorithms such as beam search or nucleus sampling with parameters such as maximum token length, temperature, and top-p. The server maintains an internal state of the model's hidden representations while iteratively predicting the next token. The server decodes the output token sequence into summary text. The server then segments the summary text according to estimated reading time, measured by word count or token count, into educational time units. The server tags each segment with metadata such as “unit 1:15 minutes,” “unit 2:15 minutes,” and so on, and stores the mapping between unit indices and text ranges in a structured table.

The server thereby improves the efficiency of content delivery. Because the server uses internal time-based segmentation rather than requiring the user or a teacher to manually segment summaries, the server reduces user-side workload. More importantly, the server reduces communication and processing overhead by enabling the terminal to request and display summary segments on demand. When the terminal requests only the next time unit, the server transmits only the corresponding portion of the summary text instead of the entire summary, which reduces network bandwidth usage and latency, particularly in environments with limited connectivity.

The server uses the same generative AI model to generate response text for learner questions. When the user submits question content such as “What economic factors led to World War II?”, the server constructs an input sequence including the question content, at least one of the summary text and the original document data, and, optionally, information indicating an education level, such as “high school” or “undergraduate.” The server encodes this information via control tokens or dedicated fields in the structured data. The server then creates a prompt sentence such as “Answer the following question in a way suitable for a high school student, using only the provided textbook context.” The server concatenates this prompt sentence with the context and the question content into a single input sequence and feeds it into the generative AI model.

The server thereby constrains the generative AI model to use only the relevant portions of the document data or summary text. This reduces hallucinations and improves answer accuracy, because the model is explicitly guided by machine-constructed context and education-level metadata. The server avoids repeatedly scanning the full document for each question by reusing the stored summarization target information and previously computed sentence importance scores. As a result, the server reduces total inference time and energy consumption compared to conventional systems that invoke a generative model on full raw text for each question.

The server further uses the generative AI model to generate evaluation assignment data. The server constructs a prompt sentence such as “Based on the following document, generate five multiple-choice questions and three short-answer questions to test understanding of the causes and consequences of World War II. Provide correct answers and brief explanations.”

The server combines this prompt sentence with document data or summary text and feeds the combined input into the generative AI model. The server parses the model's output into structured question objects that include fields such as question text, choice list, correct answer index, explanation text, and question type. The server stores these objects in a relational schema or a key-value store for subsequent retrieval.

The terminal obtains assignment data from the server and displays it to the user. The terminal renders multiple-choice questions as selectable options and renders short-answer questions as text fields. The user enters answer data and submits it to the server. The server compares answer data for objective questions with stored correct answers to perform automatic scoring. For free-text answers, the server constructs an evaluation prompt sentence such as “Evaluate the following student answer based on the model answer and rubric. Return a score from 0 to 10 and a short feedback comment.” The server then feeds the model answer, the student answer, and the rubric into the generative AI model.

The server interprets the generative AI model's output to extract a numeric score and feedback text. To ensure reliability, the server optionally applies regular-expression-based constraints or post-processing rules to check that the score is within an expected range and that the feedback text is not empty. The server aggregates per-question scores into evaluation result data, including total scores, topic-wise performance, and difficulty-wise performance. The server stores evaluation result data as structured records.

The server then generates feedback information based on the evaluation result data and learner state information. Learner state information may include historical scores, time spent on previous assignments, and patterns of questions asked. The server combines this information to output tailored feedback such as “You correctly identified the Treaty of Versailles but need more practice on economic causes,” along with a recommendation to review specific summary units.

The server thereby provides technical improvements over conventional systems in several respects. First, the server reduces redundant computation by reusing sentence-importance representations and summarization target information across summarization, question answering, and assignment generation tasks. This reduces the number of tokens processed by the generative AI model and the number of forward passes through its transformer layers, leading to faster response times and lower resource consumption. Second, the server reduces network traffic and latency by segmenting summary text into time units and transmitting only necessary segments to the terminal. Third, the server improves the determinism and stability of generative outputs by constructing machine-generated prompt sentences and input sequences that encode explicit instructions, context boundaries, and learner-level constraints, rather than directly passing through unstructured user-entered prompts.

The server uses a specific training process to prepare the generative AI model. The server, or an associated training system, uses a corpus of educational documents, question-answer pairs, and assignment examples. The training process uses a loss function such as cross-entropy loss on next-token prediction for language modeling, and may optionally include auxiliary losses for classification or sentence importance estimation. The server updates model parameters by applying gradient descent-based optimization algorithms, such as stochastic gradient descent or adaptive methods, and updates weight tensors according to computed gradients. The training process may use data augmentation techniques such as paraphrasing of questions, reordering of document sections, or masking of sentences to improve robustness. The server stores the trained model parameters in nonvolatile storage for later inference.

The server and the terminal are not limited to a single configuration. In another embodiment, the server distributes computation between multiple machines, where one machine performs natural language preprocessing and sentence importance scoring, and another machine hosts the generative AI model on dedicated GPU hardware. In another embodiment, the terminal performs partial preprocessing, such as tokenization and compression of document data, before transmission to the server to reduce network load. In yet another embodiment, the generative AI model includes an encoder-decoder architecture instead of a purely autoregressive decoder-only architecture, where the encoder processes the document data and the decoder generates summaries and answers conditioned on encoder outputs.

The server can also adjust algorithmic settings dynamically based on system load or learner profile. For example, the server can reduce the maximum number of tokens per generation or switch from beam search to greedy decoding in order to satisfy real-time constraints during peak usage periods. Conversely, the server can increase beam width or use temperature-controlled sampling to enhance answer diversity when latency constraints are relaxed.

The server uses nonconventional data structures and control logic to achieve these technical effects. By explicitly storing and indexing summarization target information, time-unit segmentation metadata, and learner state information, the server creates a layered representation of educational content that is not present in general-purpose document-processing systems. This representation allows the server to orchestrate multi-stage processing in which outputs of one stage (such as sentence importance scores) are reused as inputs to other stages (such as question answering), thereby improving computational efficiency and output consistency. The processing is therefore not a mere automation of human teaching, but rather a machine-specific pipeline that exploits internal vector representations, control tokens, and structured metadata to improve the functioning of the computing system itself in terms of speed, resource usage, and output reliability.

The user, through the terminal, can thus engage in an interactive educational experience in which the server executes a series of coordinated, technically detailed operations. These operations include machine-level text preprocessing, vector embedding computation, transformer-based inference, time-unit-based segmentation, structured assignment generation, and automatic scoring, all driven by carefully constructed prompt sentences and input sequences. The combination of these mechanisms enables the claimed system to implement the invention in a manner that can be practiced by others in the field and that provides concrete technological improvements to computer-implemented educational processing.

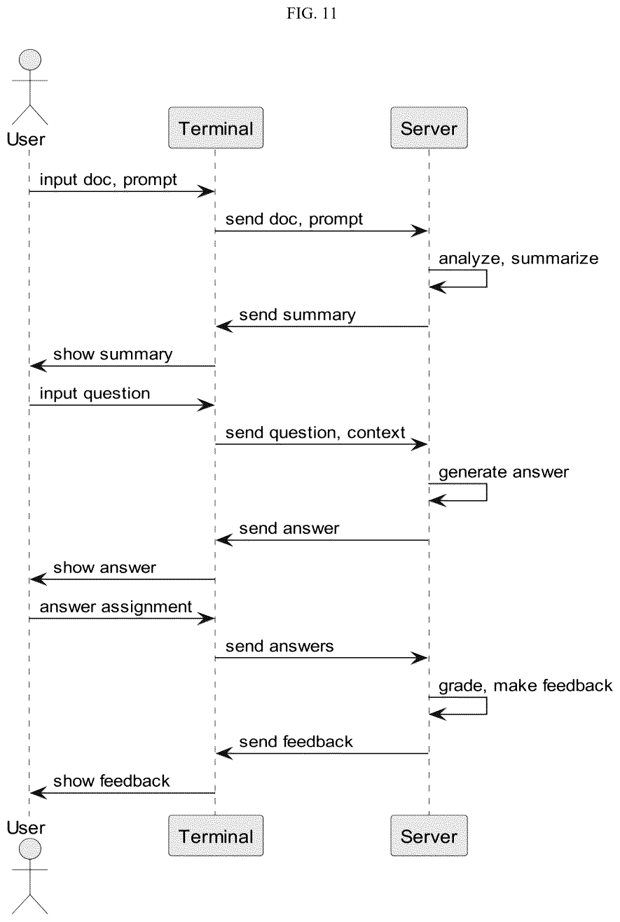

The following describes the processing flow using FIG. 11.

### Step 1:

The user operates the terminal to provide initial input.

The user opens a learning screen on the terminal and selects one or more electronic documents to be used as document data, such as a textbook chapter that has been converted into plain text. The user then enters a prompt sentence, such as “Please summarize the causes and consequences of World War II in a way suitable for a 15-minute class segment.” Input: raw document text, prompt sentence entered by the user.

Output: UI-level input values in the terminal (text fields and document selection).

### Step 2:

The terminal converts the user input into a machine-transmittable request.

The terminal collects the document text and the prompt sentence from the UI components, associates them with identifiers such as a session ID and a user ID, and packages them into a request structure. The terminal may perform basic validation such as checking that the text is not empty and truncating overly long input according to preset limits. The terminal then sends the structured request to the server over a network using a secure protocol.

Input: UI-level document text and prompt sentence.

Output: a network request payload containing document data and the prompt sentence.

### Step 3:

The server receives and stores the request data.

The server accepts the network request through a communication interface, parses the request headers and body, and extracts the document data and the prompt sentence. The server assigns a unique session identifier if one is not already provided, and stores the raw text and associated metadata (user ID, timestamps) in nonvolatile storage or in-memory data structures. The server checks encoding, removes unsupported characters, and logs the transaction for traceability.

Input: network request payload with document data and prompt sentence.

Output: normalized and stored raw document data and prompt sentence associated with a session ID.

### Step 4:

The server performs text normalization and tokenization.

The server uses text-processing routines to normalize the document data and the prompt sentence, for example by standardizing whitespace, normalizing punctuation, and converting characters to a unified encoding. The server then applies a tokenizer associated with the generative AI model to segment the normalized text into token IDs. The server generates token sequences for the prompt sentence and for each segment of the document data.

Input: normalized document text and prompt sentence.

Output: token sequences representing the document data and the prompt sentence.

### Step 5:

The server analyzes document sentences and computes sentence importance.

The server divides the document data into sentence units using sentence boundary detection. For each sentence, the server computes an embedding vector using a natural language processing engine or a sentence-encoding model. The server also computes an embedding for the prompt sentence. The server then calculates a similarity score between each sentence embedding and the prompt embedding, for example using cosine similarity. The server may further apply a learned linear layer or weighting function to adjust the importance scores. The server stores, for each sentence, the importance score and the sentence index within the document.

Input: tokenized document sentences and prompt sentence embedding.

Output: a list of sentences with associated importance scores and indices.

### Step 6:

The server selects summarization target information.

The server sorts the sentences based on their importance scores and selects a subset of sentences that exceed a threshold or are among the top-k scores. The server optionally adds neighboring sentences to preserve context, merging them into segments. The server builds a summarization target representation consisting of an ordered list of selected text segments and corresponding token indices. This representation reduces document length while preserving key content.

Input: sentences with importance scores and indices.

Output: summarization target information in the form of selected text segments and token indices.

### Step 7:

The server constructs a summarization input sequence for the generative AI model.

The server generates a machine-constructed prompt sentence for summarization, such as “Understand the following textbook passage and generate a summary that can be presented in 15-minute lesson units.” The server concatenates control tokens indicating sections (for example “Instruction:”, “Document:” and “Summary:”) with tokens representing the internal prompt sentence and the summarization target information. The server arranges these tokens into a single ordered input sequence and converts it into tensor form suitable for the generative AI model.

Input: summarization target information and internal summarization prompt sentence.

Output: a structured input sequence tensor for the generative AI model.

### Step 8:

The server executes summarization inference using the generative AI model.

The server loads the input sequence tensor into CPU or GPU memory and performs a forward pass through the transformer-based generative AI model. At each decoding step, the server computes attention over previous tokens, updates hidden states, and produces probability distributions over the vocabulary. The server selects the next token according to a decoding strategy such as beam search or nucleus sampling. The server iterates until an end-of-sequence condition is met or a maximum length is reached. The server then decodes the generated token IDs into human-readable summary text.

Input: input sequence tensor for summarization.

Output: generated summary text representing a condensed version of the document data.

### Step 9:

The server segments the summary text into educational time units.

The server estimates reading time by counting words or tokens in the summary text and applying an assumed reading speed (for example, words per minute). The server splits the summary text into segments that correspond to target educational time units, such as 10-15 minutes per segment. The server adjusts segment boundaries to fall at sentence breaks and ensures that each segment remains coherent. The server assigns metadata to each segment, including unit number and estimated duration, and stores this information in a segment table.

Input: full summary text.

Output: multiple summary segments, each annotated with an educational time unit and associated metadata.

### Step 10:

The server prepares and sends a summarization response to the terminal.

The server gathers the segmented summary units and associated metadata, formats them into a structured response object, and serializes the object. The server then sends the response over the network to the terminal. The server may compress the data or omit segments that are not immediately needed to reduce network load.

Input: segmented summary units and metadata.

Output: network response containing summary segments designed for time-unit-based presentation.

### Step 11:

The terminal receives and displays the summary segments.

The terminal parses the received response object, extracts each summary unit, and stores them in local memory for navigation. The terminal renders the first summary unit on the display using its user interface components and may provide navigation controls for the user to move between units. The terminal may also display unit metadata such as “Lesson 1: approx. 15 minutes.”

Input: network response with summary segments.

Output: on-screen presentation of summary text segmented by educational time units.

### Step 12:

The user reviews the summary and submits a follow-up question.

The user reads the displayed summary on the terminal. When the user has a question, the user enters a new prompt sentence in a question input field, such as “What economic factors led to World War II?” or “Why did the Treaty of Versailles contribute to the outbreak of World War II? Explain briefly.” The user then triggers a send operation through a button or similar control.

Input: displayed summary units and user's intent to ask a question.

Output: new question prompt sentence entered on the terminal.

### Step 13:

The terminal sends the question content and context to the server.

The terminal collects the question content, identifies the related summary unit or document section, and forms a request structure that includes the question text, references to relevant summary units, and optionally user-level metadata such as education level. The terminal transmits this structure to the server over the network.

Input: question prompt sentence and contextual identifiers from the terminal.

Output: network request containing question content, context references, and learner metadata.

### Step 14:

The server constructs a question-answering input sequence.

The server receives the request, retrieves the referenced summary text or document segments from storage, and tokenizes the question content and context. The server then generates a question-answering prompt sentence such as “Answer the following question using only the provided textbook context, in a way suitable for a high school student.” The server arranges control tokens, the prompt sentence, the contextual summary or document text, and the question content into a combined input sequence. The server converts the sequence into token IDs and then into a tensor for model inference.

Input: question content, contextual summary or document segments, and learner-level metadata.

Output: structured question-answering input sequence tensor for the generative AI model.

### Step 15:

The server generates response text using the generative AI model.

The server feeds the question-answering input sequence tensor into the generative AI model and performs autoregressive decoding. The server computes attention over both the question tokens and the contextual tokens and produces a sequence of output tokens that form an answer. The server decodes the token sequence into response text, optionally truncates or refines the text according to length and style constraints, and checks that the response is consistent with the provided context.

Input: question-answering input sequence tensor.

Output: response text that addresses the user's question with reference to the relevant educational content.

### Step 16:

The server sends the response text to the terminal.

The server embeds the response text, along with optional metadata such as related topics or confidence indicators, into a response object and transmits it over the network to the terminal.

Input: generated response text and associated metadata.

Output: network response containing the answer to the question.

### Step 17:

The terminal displays the answer and allows further interaction.

The terminal parses the response, extracts the response text, and renders it on the display in association with the corresponding question and summary unit. The terminal may highlight key terms or provide links to relevant summary units. The user can read the answer and, if necessary, ask additional questions by repeating the previous steps.

Input: network response with response text.

Output: on-screen presentation of the answer and an updated interactive view for the user.

### Step 18:

The server generates evaluation assignment data using the generative AI model.

Separately from the user's immediate queries, the server retrieves document data and learning objectives associated with a course or session. The server constructs an assignment-generation prompt sentence such as “Based on the following document, generate five multiple-choice questions and three short-answer questions to test understanding of the causes and consequences of World War II. Provide correct answers and brief explanations.”

The server concatenates this prompt sentence with the relevant document segments, tokenizes the result, and forms an input sequence for the generative AI model. The server then performs generative decoding to produce a text that contains questions, choices, correct answers, and explanations. The server parses this generated text into structured evaluation assignment data, including question type, text, options, correct answer, and explanation, and stores them in a database.

Input: document data and learning objectives.

Output: structured evaluation assignment data suitable for presentation and grading.

### Step 19:

The terminal obtains and presents assignments to the user.

The terminal requests available assignments from the server and receives structured evaluation assignment data. The terminal formats multiple-choice questions with selectable options and free-response questions with input fields. The terminal displays each assignment item sequentially or in groups, allowing the user to respond.

Input: structured evaluation assignment data from the server.

Output: on-screen representation of assignments ready for user responses.

### Step 20:

The user submits answer data for the assignments.

The user reads each question on the terminal and selects choices or enters free-text answers. After completing the assignment, the user submits all answers via a control such as a “Submit” button.

Input: displayed assignment questions and user interactions.

Output: user answer data collected by the terminal.

### Step 21:

The terminal transmits the answer data to the server.

The terminal aggregates all user answers, associates them with assignment identifiers and question identifiers, and forms a submission payload. The terminal then sends this payload to the server over the network for evaluation.

Input: collected answer data with identifiers.

Output: network request containing answer data for evaluation assignment data.

### Step 22:

The server evaluates the answer data and generates evaluation result data.

The server retrieves the corresponding evaluation assignment data and, for objective items, compares the user's selected options or numeric values to the stored correct answers. The server computes correctness flags and partial scores as needed. For free-text answers, the server constructs an evaluation prompt sentence such as “Evaluate the following student answer based on the model answer and rubric. Return a score from 0 to 10 and a short feedback comment.” The server concatenates the model answer, the student's answer, and the rubric, tokenizes the concatenated text, and generates an input sequence for the generative AI model. The server runs the model to obtain an output containing a score and feedback. The server parses this output to extract the numeric score and feedback text, and aggregates all per-question scores into evaluation result data, including total scores and per-topic performance indicators.

Input: answer data, evaluation assignment data, and rubrics.

Output: evaluation result data including scores, correctness indicators, and per-question evaluations.

### Step 23:

The server generates feedback information and returns it to the terminal.

The server combines the evaluation result data with learner state information, such as previous performance history and progress in the course, to generate feedback information.

The server composes feedback messages like “You correctly identified the main political causes, but need more practice on the economic factors,” and may recommend specific summary units or additional assignments. The server constructs a feedback object containing textual comments, scores, and recommended actions, and transmits this object to the terminal.

Input: evaluation result data and learner state information.

Output: feedback information sent to the terminal.

### Step 24:

The terminal displays feedback and supports further learning actions.

The terminal receives the feedback information, parses it, and displays it on a result screen that includes total scores, per-question breakdowns, and explanatory comments. The terminal may offer navigation controls that allow the user to jump directly from feedback items to relevant summary units or to initiate new assignments. The user can use this information to decide on subsequent learning actions, such as re-reading specific summary segments or asking new questions.

Input: feedback information from the server.

Output: visual feedback presentation and an updated learning interface for the user.

### Application Example 1

Description follows regarding a flow of the specific processing in an Application Example 1. The units of the system described below are implemented by the data processing device 12 and the smart device 14. The data processing device 12 is called a “server” and the smart device 14 is called a “terminal”.

Conventional computer-implemented learning support systems typically manage educational content as static documents or simple chapter-based units, and rely on fixed, pre-authored summaries and answers. Such systems do not dynamically adapt the granularity of content to actual instructional units (for example, class periods), and they do not use generative AI models in a structured, system-level way to generate and deliver summaries and answers. As a result, existing systems often require significant manual authoring effort, cannot efficiently reuse large volumes of textbook data, and do not provide fine-grained, on-demand summaries aligned with specific instructional units.

Furthermore, many existing systems offload most of the “intelligence” to an external AI service by sending raw or semi-processed text, without implementing specialized control logic, prompt management, or indexing structures on the server side. This leads to inefficient use of computational resources, difficulty in managing consistency of generated content across different class periods, and limited ability to systematically retrieve and present AI-generated outputs to terminals. In particular, conventional architectures fail to optimize the flow by which digital educational information is segmented, summarized, indexed, and delivered to user terminals in a way that supports fast access and pedagogically relevant views (for example, per class period summaries) on resource-constrained devices.

Additionally, existing systems rarely integrate emotion analysis and feedback generation in a way that is technically coordinated with the generation of summaries and answers. Emotion recognition, where present, is often implemented as a separate function that is not tightly coupled with the server's control over AI-based content generation and delivery. This separation prevents the system from adjusting content delivery or feedback in a computationally coherent manner, thereby underutilizing available processing capabilities and data structures.

In view of the above, there is a need for an improved computer-implemented system and server architecture that: (i) programmatically segments educational information into instructional units, (ii) constructs and manages structured prompt sentences for generative AI models, (iii) stores and indexes AI-generated summaries and answers on an instructional-unit basis, and (iv) coordinates these processes with emotion analysis and feedback delivery. Such a system should improve the technical performance of server-side processing and data retrieval, reduce redundant computations and network transfers, and provide user terminals with efficiently accessible, context-appropriate summaries and answers that are tightly integrated with learner-state-based feedback.

The specific processing by the specific processing unit 290 of the data processing device 12 in Application Example 1 is realized by the following means.

The present invention provides a server comprising a processor configured to acquire educational information from a storage unit, analyze the educational information, divide the educational information into instructional units corresponding to class periods, and generate text data for each instructional unit, to construct, for each instructional unit, a prompt sentence based on the text data for the instructional unit and learning theme information, the prompt sentence instructing a generative AI model to generate a summary of the text data, and to provide input data including the prompt sentence to the generative AI model so as to cause the generative AI model to generate summary text data for each instructional unit, to store the generated summary text data in the storage unit in association with the corresponding instructional unit and assign index information to the summary text data in a form searchable on an instructional-unit basis, to receive, from a user information processing terminal, a request signal, identify an instructional unit designated by the user information processing terminal based on the request signal, and distribute to the user information processing terminal the summary text data associated with the identified instructional unit, to analyze contents of the educational information using a natural language processing engine, extract important information from the educational information, and generate summary text data of the educational information, to provide to the generative AI model a prompt sentence instructing understanding of the educational information and a prompt sentence instructing understanding of question content, and to cause the generative AI model to generate answer text data to questions from a learner based on the prompt sentence, and to analyze an emotion of the learner based on learner state information, generate feedback information according to an analysis result of the emotion, and output the feedback information to the user information processing terminal. This enables a technically improved server-side workflow in which large-scale educational information is automatically segmented into instructional units, converted into structured prompt sentences, processed by a generative AI model under explicit server control, and stored with unit-level indexing so that summaries and answers can be efficiently generated, retrieved, and distributed to user terminals together with emotion-based feedback, thereby reducing computational redundancy, improving response times, and optimizing the use of network and processing resources.

The term “educational information” refers to electronic content used for learning activities, including but not limited to textbook data, lecture materials, course descriptions, and other instructional documents in digital form.

The term “storage unit” refers to a hardware or software component configured to store data, such as a memory device, a database system, a file system, or a networked storage service.

The term “instructional unit” refers to a segment of educational information corresponding to a discrete teaching or learning period, including but not limited to a class period, lesson, or session.

The term “class period” refers to a predetermined time slot in an instructional schedule during which a particular portion of educational content is taught or studied.

The term “text data” refers to information represented in a character-based format, including sentences, paragraphs, and other textual structures derived from educational information or generated by computation.

The term “learning theme information” refers to metadata representing a topic, subject, or theme associated with an instructional unit, such as a chapter title, lesson objective, or key concept description.

The term “prompt sentence” refers to a machine-interpretable instruction string, including one or more natural language sentences, provided as input to a generative AI model to specify a task, such as summarization, explanation, or question answering.

The term “generative AI model” refers to a computational model that generates text or other content in response to input data, such as a large-scale machine learning model trained to perform natural language generation.

The term “summary text data” refers to condensed text generated from original educational information, in which key points are extracted and expressed in a shorter form while retaining essential meaning.

The term “index information” refers to metadata or structural data used to enable retrieval or search of stored data, including identifiers, keys, tags, or pointers associated with summary text data on an instructional-unit basis.

The term “user information processing terminal” refers to an electronic device operated by a user, such as a smartphone, tablet, notebook computer, or desktop computer, configured to communicate with the server and present information.

The term “request signal” refers to electronic data transmitted from a user information processing terminal to the server to request processing or retrieval of information, including but not limited to an HTTP request or similar communication.

The term “display control” refers to processing performed to determine how information is rendered on a screen, including arranging, updating, and switching displayed content in response to user operations.

The term “natural language processing engine” refers to a software component or system configured to analyze, interpret, and process human language text, including tasks such as parsing, semantic analysis, information extraction, and summarization.

The term “important information” refers to portions of educational information determined, by analysis, to be central, salient, or pedagogically significant, such as key concepts, main events, definitions, or conclusions.

The term “answer text data” refers to text generated in response to a question from a learner, including explanations, solutions, clarifications, or other responsive content.

The term “learner” refers to an individual who engages in learning activities using the system, including but not limited to a student, pupil, or trainee.

The term “learner state information” refers to data representing a condition or behavior of a learner, including but not limited to interaction logs, response patterns, biometric signals, or facial expressions, used for emotion analysis.

The term “emotion” refers to an inferred affective state of a learner, such as interest, confusion, frustration, or satisfaction, derived from learner state information by computational analysis.

The term “feedback information” refers to information generated for presentation to the learner based on emotion analysis or other criteria, including encouragement, guidance, warnings, recommendations, or adaptive learning instructions.

In one embodiment, a server implements the claimed system by executing computer programs on a general-purpose computing platform. The server includes a multi-core processor, a main memory, a non-volatile storage device, a network interface, and an operating system such as a UNIX-like operating system. The server executes application software implemented, for example, using a web application framework. The server stores educational information, such as textbook content and course materials, in a storage unit implemented by a relational database management system and a file system. The server further communicates with one or more terminals operated by users through a communication network, such as a wired or wireless IP network.

The server uses specific software components to implement data processing. For example, the server uses a document parsing library, such as a PDF or EPUB parsing library, to convert educational information stored in file formats into text data. The server uses a natural language processing engine, such as a statistical or neural network-based text analysis library, to segment, tokenize, and annotate text data. The server further interfaces with a generative AI model, such as a transformer-based language model, through an application programming interface. The generative AI model may be executed on a remote computing infrastructure equipped with graphics processing units or tensor processing units.

The server stores educational information in a structured way. The server converts original textbook files into normalized text segments and writes these segments into database tables.

The server associates each text segment with metadata such as course identifier, chapter identifier, and page range. The server then generates records representing instructional units corresponding to class periods. Each instructional unit record includes an identifier, a reference to one or more text segments, a learning theme string, and additional attributes such as target grade level and estimated reading time. This explicit data structure allows the server to access and process educational information at an instructional-unit level rather than as monolithic documents.

The server uses a natural language processing engine to analyze the educational information.

The server executes sentence segmentation, part-of-speech tagging, and dependency parsing on the text data. The server applies an information extraction algorithm to identify important information, such as named entities, domain terms, dates, and causal relations. For instance, the server computes term frequencies and importance scores using a weighting scheme such as TF-IDF, and the server combines these scores with syntactic features to determine candidate key sentences. By pre-processing text in this way, the server reduces the amount of data that must be transmitted to the generative AI model and improves the relevance of subsequent summarization.

The server constructs a prompt sentence for the generative AI model. The server stores one or more prompt templates as text strings. The server fills variables within these templates using data fields from the instructional unit records. For example, the server generates a prompt sentence of the following form:

“Please summarize the following textbook content. The theme is ‘Causes and course of World War II’. Create a concise summary suitable for one class period. Text: [instructional unit text here].”

The server may also generate a prompt sentence for answering learner questions, such as: “You are an educational assistant. Based on the following textbook content, answer the learner's question clearly and concisely. Textbook content: [relevant instructional unit text]. Question: [learner question].”

The server programmatically selects and concatenates the instructional unit text, the learning theme information, and optional constraints such as desired length or target reading level.

The server therefore applies a non-trivial, rule-based prompt construction algorithm that is optimized for instructional units, rather than simply passing unstructured text to the generative AI model.

The server sends the constructed prompt sentence to the generative AI model. The generative AI model is, in one embodiment, a transformer architecture comprising multiple self-attention and feedforward layers. The generative AI model receives the prompt sentence as a sequence of tokens. The generative AI model internally embeds the tokens into high-dimensional vectors using learned embedding matrices, applies multi-head self-attention at each layer to compute contextualized representations, and passes these representations through non-linear transformations. The generative AI model computes output token probabilities using a softmax function and generates summary text data or answer text data token by token according to a decoding algorithm such as greedy search or beam search. The generative AI model has been trained in advance on a large corpus by minimizing a loss function such as cross-entropy between predicted and target tokens, and by updating model weights using gradient-based optimization. Data augmentation techniques, such as masking, shuffling, or paraphrase generation, may be used during training to improve robustness.

The server controls how the generative AI model is used by setting parameters such as maximum token length, generation temperature, and top-k or top-p sampling thresholds. The server may adapt these parameters based on properties of the instructional unit, such as word count, complexity, or learner level, thereby achieving a technical effect of controlling computational load and maintaining consistent output length. Because the server manages prompts and parameters in a structured way, the summarization process is not a mere automation of manual summarization; instead, the system optimizes the interaction between local pre-processing, remote model inference, and local post-processing to achieve improved speed, consistency, and resource utilization.

The server receives the output sequence from the generative AI model as summary text data or answer text data. The server parses the returned data, performs post-processing such as trimming, normalization of line breaks, and removal of extraneous content, and stores the processed output in the storage unit. The server associates each piece of summary text data with the corresponding instructional unit identifier. The server further generates index information, such as term indices or keyword lists, using feature extraction algorithms. For example, the server computes keyword vectors using a term weighting algorithm and stores them in a separate table. The server can also compute embeddings for summaries using a separate neural network model and store these embeddings as numeric vectors. These specialized data structures allow the server to perform efficient similarity search and retrieval of summaries.

The server implements a particular indexing strategy that contributes to technical improvement. The server maintains indices at both the instructional-unit level and the keyword level. When the server updates an instructional unit, the server updates only the corresponding index entries, avoiding full reindexing of the entire textbook. This incremental indexing reduces database load and improves response times for queries. The server thus achieves improved data management and computational efficiency compared with naive implementations that store entire documents as undifferentiated blobs.

The server analyzes learner state information to infer an emotion of the learner. The terminal may capture interaction logs, such as response time to questions, frequency of scrolling, and pattern of switching between instructional units, and send such logs to the server. In some embodiments, the terminal may capture additional signals, such as camera images or audio input, which are pre-processed locally to extract features such as facial expression vectors or voice prosody metrics. The server receives these feature vectors and applies an emotion recognition engine.

The server implements the emotion recognition engine as a classifier, which may be a neural network or another machine learning model. For example, the server employs a recurrent neural network or transformer-based classifier that has been trained on feature sequences labeled with emotion categories. The model receives a sequence of learner state features, computes an internal representation using attention mechanisms or recurrent connections, and outputs probabilities for emotion categories such as confusion, engagement, or frustration.

The server uses a loss function, such as cross-entropy, during training, and updates weights using gradient descent. The server can also apply rule-based post-processing, such as thresholds on probabilities and temporal smoothing, to stabilize the inferred emotion state over time.

The server uses the inferred emotion to generate feedback information. For example, if the emotion classifier outputs a high probability of confusion, the server selects or generates feedback instructing the learner to review a specific summary or provides an additional explanation. If the emotion classifier outputs a high probability of engagement, the server may prompt the learner to proceed to a more advanced instructional unit. These actions are not business rules alone; they rely on the specific combination of emotion inference algorithms and the indexed instructional-unit summaries stored in the system. The tight coupling of these components yields a technical effect: the server dynamically adjusts data retrieval and presentation strategies based on computed emotion states, which improves the efficiency of learner-system interaction and reduces unnecessary data transfer.

The terminal operates as a user information processing terminal. The terminal executes a client application that communicates with the server through network protocols. The terminal presents a user interface allowing the user to select textbooks, courses, and instructional units.

The terminal displays lists of instructional units based on metadata received from the server. When the user selects a specific instructional unit, the terminal transmits a request signal, such as an HTTP request, to the server, including an instructional unit identifier.

The terminal receives summary text data and answer text data from the server. The terminal displays this data in a scrollable view, using user interface components. The terminal may implement local caching of summaries by storing recently accessed content in a local database, thereby reducing network latency and server load when the user revisits the same instructional units. The terminal also transmits learner state information, such as interaction logs and optional feature vectors, to the server according to configured privacy and security policies.

The user interacts with the system through the terminal rather than directly with the server. The user selects instructional units, reads summaries, submits questions, and receives answers and feedback. The user can also request customized summaries by specifying, for example, that a summary should focus only on causes of an event or use simplified language. In such a case, the server constructs a more specialized prompt sentence, for instance: “Please summarize the following textbook content. The theme is ‘Causes and course of World War II’. Focus only on causes, and use language suitable for middle-school students. Text: [instructional unit text].”

By varying prompt content based on explicit user input and internal metadata, the server controls the generative AI model in a way that is technically distinct from simple, static prompts.

The server uses a modular architecture. A segmentation module handles division of educational information into instructional units. A prompt management module controls creation, storage, and retrieval of prompt templates. A summarization module manages interaction with the generative AI model, including parameter selection and error handling. An indexing module manages summary and keyword indices. An emotion analysis module processes learner state information and generates feedback information. A distribution module handles receipt of terminal requests, retrieval of summaries and feedback, and return of data to terminals. Each module communicates through defined interfaces and uses shared database schemas. This modular configuration improves maintainability and scalability of the system, and it enables independent optimization of data paths, including caching strategies and batch processing for summarization.

The server improves computer technology in multiple ways. First, by segmenting educational information into instructional units and generating summaries at that granularity, the server reduces the amount of text processed and transmitted per request, leading to improved response time and reduced network load. Second, by integrating a natural language processing engine for pre-processing and an indexing module for fine-grained retrieval, the server reduces redundant calls to the generative AI model, as the server can reuse stored summaries instead of regenerating them for each request. Third, by coordinating emotion analysis and content distribution, the server adjusts retrieval and presentation strategies in real time, prioritizing certain summaries or explanations, which reduces unnecessary rendering and data transfer on the terminal. Fourth, by employing structured prompt construction algorithms that use metadata and analysis results, the server improves the consistency and accuracy of generated summaries and answers, thereby reducing the need for manual post-editing and lowering error rates.

The server may employ alternative implementations. In one variation, the generative AI model executes locally on the same physical machine as the server, using dedicated accelerator hardware. In another variation, the natural language processing engine and the emotion recognition engine are deployed as microservices, each with its own scaling policy. In still another variation, the server uses different model architectures, such as encoder-decoder transformers for summarization and convolutional neural networks for emotion analysis based on image features. The server can also vary algorithms for indexing, such as using inverted indices or vector databases, depending on the size and nature of the stored summaries. These alternative embodiments still conform to the essential structure in which the server segments educational information, constructs and manages prompt sentences, orchestrates generative AI model operations, indexes and retrieves instructional-unit-level summaries and answers, and coordinates these processes with emotion-based feedback for terminals operated by users.

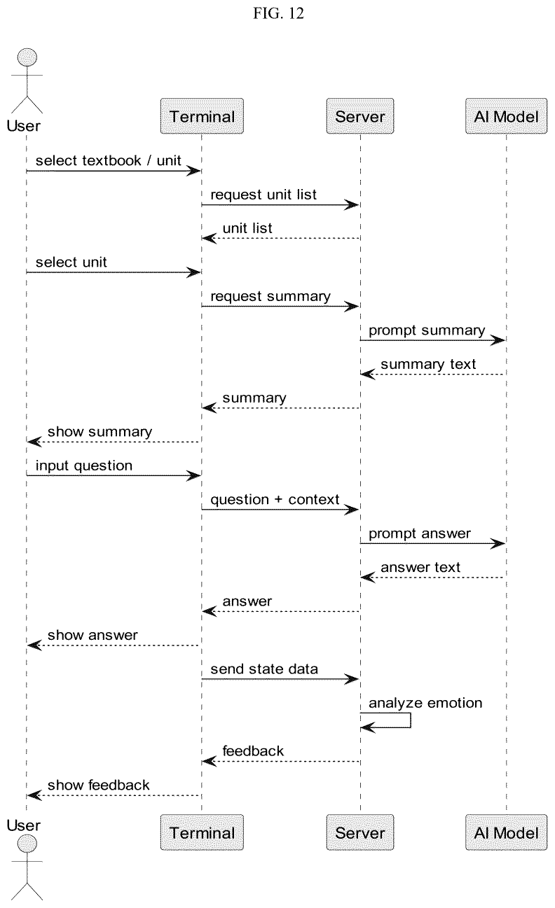

The following describes the processing flow using FIG. 12.

### Step 1:

Server receives educational information as input files from an external source and converts the files into normalized text data as output.

Server accepts one or more digital textbook files (for example, PDF, EPUB, or DOCX) through an upload interface or an API call. As input, the server obtains binary file data along with metadata such as course ID, subject, and grade level. Server invokes a document-parsing module (for example, using a PDF parsing library or EPUB parser) to extract character strings from each page of the file. Server performs data processing by decoding the binary contents, removing control characters, normalizing line breaks, and concatenating page texts into a continuous text sequence. As output, the server stores normalized text data records together with the associated metadata in a database or storage unit.

### Step 2:

Server segments the normalized text data into instructional units as output based on structural and configuration information as input.

Server retrieves the normalized text and metadata from the storage unit as input, including indicators such as chapter headings, section markers, and page ranges. Server uses a natural language processing engine to split the text into paragraphs and sentences, and server applies a segmentation algorithm that groups these paragraphs into instructional units corresponding to class periods. The segmentation algorithm may use rules, such as a maximum number of words or paragraphs per instructional unit, and references to chapter boundaries. Server performs data processing by iterating through the text sequence, computing cumulative word counts, and assigning instructional unit identifiers when thresholds or boundary conditions are met. As output, the server writes instructional-unit records, each containing an instructional unit ID, start and end offsets in the text, and a learning theme string, to the database.

### Step 3:

Server analyzes each instructional-unit text segment as input and extracts important information as structured data as output.

Server reads the text associated with a particular instructional unit from the database as input. Server applies the natural language processing engine to tokenize the text, assign part-of-speech tags, and identify named entities, dates, and domain terms. Server executes an importance scoring algorithm, such as TF-IDF or sentence ranking, to compute numerical scores for terms and sentences. Server performs data operations by aggregating these scores, selecting high-scoring sentences as candidate key sentences, and generating a list of keywords. As output, the server stores the structured analysis results, including key sentences and keyword lists, linked to the instructional unit ID in auxiliary tables.

### Step 4:

Server constructs a prompt sentence as output using the instructional-unit text and analysis results as input.

Server retrieves, as input, the instructional-unit text segment, the learning theme information, and the list of key sentences and keywords. Server selects an appropriate prompt template from a prompt library, such as:

“Please summarize the following textbook content. The theme is ‘[theme]’. Create a concise summary suitable for one class period. Text: [content].”

Server performs string processing by replacing placeholders with the actual theme and text content, optionally appending key sentences or keywords to guide the generative AI model. Server adjusts the prompt length by truncating or chunking the instructional-unit text if the token count exceeds a predefined limit. As output, the server generates a complete prompt sentence string and stores it temporarily in memory or in a prompt log associated with the instructional unit.

### Step 5:

Server sends the constructed prompt sentence as input to the generative AI model and receives summary text data as output.

Server prepares a request payload that includes the prompt sentence, a model identifier, and configuration parameters such as maximum tokens, temperature, and sampling options. Server transmits this payload via an API call over a network to a generative AI model implemented as a transformer-based neural network. The generative AI model processes the input tokens internally by applying embedding layers, multi-head self-attention, feedforward layers, and a softmax output layer to generate output tokens representing the summary. Server receives the generated token sequence as a response and decodes it to a summary text string. As output, the server obtains summary text data corresponding to the instructional unit.

### Step 6:

Server post-processes the summary text data as input and produces a normalized, indexed summary record as output.

Server takes the raw summary text string from the generative AI model as input and performs cleaning operations such as trimming whitespace, unifying punctuation, and removing duplicated phrases. Server then executes a keyword extraction or embedding generation algorithm on the cleaned summary to create index information. Server performs data operations by inserting the summary text, associated instructional unit ID, and index information into the summaries table and index tables in the storage unit. As output, the server creates a persistent, searchable summary record for the instructional unit.

### Step 7:

Server prepares a list of instructional units with summary availability information as output using course and user data as input.

Server receives, as input, a course identifier and user authentication data from the terminal. Server queries the instructional-unit records for the specified course and joins them with the summaries table to determine which instructional units already have summaries. Server performs data processing by constructing a list structure that includes each instructional unit ID, title, and a flag indicating whether a summary exists. As output, the server sends this list to the terminal in a structured response format.

### Step 8:

Terminal receives the instructional-unit list as input and displays a selectable menu of instructional units as output.

Terminal obtains the list of instructional units from the server as input, parses the structured data, and constructs visual elements such as list items or buttons for each instructional unit. Terminal performs UI rendering by placing these elements on the screen, labeling them with titles, and marking items with available summaries. As output, the terminal presents an interactive interface that allows the user to select an instructional unit.

### Step 9:

User selects a particular instructional unit as input to the terminal, and the terminal generates a summary retrieval request as output.

User interacts with the displayed list on the terminal by tapping or clicking an instructional-unit entry. Terminal receives this user input as an event, extracts the corresponding instructional unit ID, and constructs a request message. Terminal performs data processing by including the instructional unit ID and the user's authentication token in the request. As output, the terminal sends a request signal to the server to retrieve the summary for the selected instructional unit.

### Step 10:

Server retrieves the requested instructional-unit summary as input and returns the corresponding summary text data as output.

Server receives the summary retrieval request and validates the user authentication data as input. Server queries the storage unit using the instructional unit ID to fetch the associated summary text and index information. Server may perform additional data processing, such as logging access events or updating usage statistics. As output, the server sends the summary text data and related metadata (such as title and theme) back to the terminal.

### Step 11:

Terminal receives the summary text data as input and displays the summary to the user as output.

Terminal obtains the summary text and metadata from the server as input, parses the received data, and constructs display components such as a title header and a text area. Terminal performs rendering operations to arrange these components on the screen, enabling scrolling and text selection if necessary. As output, the terminal presents the summary text to the user in a format suitable for reading during a class period or review session.

### Step 12:

User reads the displayed summary as input and may submit a question as output. User reviews the summary text shown on the terminal and identifies parts that require clarification. User enters a natural language question using an input field on the terminal. Terminal captures the question text as input from the user and constructs a question submission request as output, including the question, the instructional unit ID, and context information such as previously viewed summaries.

### Step 13:

Server receives the learner's question and instructional-unit context as input and constructs a question-answer prompt sentence as output.

Server obtains the question text, the instructional unit ID, and optionally the relevant summary or underlying instructional-unit text as input. Server selects a question-answer prompt template, such as:

“You are an educational assistant. Based on the following textbook content, answer the learner's question clearly and concisely. Textbook content: [instructional unit text]. Question: [learner question].”

Server performs string manipulation by inserting the appropriate instructional-unit text and question into the template, possibly appending key sentences or keywords extracted earlier. As output, the server generates a question-answer prompt sentence tailored to the learner's query.

### Step 14:

Server sends the question-answer prompt sentence as input to the generative AI model and obtains answer text data as output.

Server packages the prompt sentence, model identifier, and configuration parameters into a request payload and transmits it to the generative AI model. The generative AI model processes the sequence of tokens internally using its neural network architecture to compute a context-aware answer sequence. Server receives the generated token sequence, decodes it to a text string, and performs minor post-processing. As output, the server obtains answer text data addressing the learner's question.

### Step 15:

Server analyzes learner state information as input and generates emotion-based feedback information as output.

Server receives learner state information from the terminal, such as interaction timing, question frequency, or pre-processed feature vectors representing facial expressions or voice characteristics. Server applies an emotion recognition engine to this input, computing feature representations and class probabilities for emotion categories. Server performs data processing by applying classification thresholds and temporal smoothing to infer a stable emotion state. Based on the inferred emotion and the context of the instructional unit, server selects or generates feedback information, such as encouragement to continue, suggestion to review a prior summary, or recommendation to slow down. As output, the server produces feedback text or control signals and sends them to the terminal together with or separate from the answer text.

### Step 16:

Terminal receives answer text data and feedback information as input and presents them to the user as output.

Terminal parses the received answer text and feedback strings from the server as input. Terminal updates the user interface by displaying the answer below or beside the summary text and by presenting feedback in a designated area, such as a notification bar or dialog. Terminal may highlight instructional units suggested for review or emphasize specific summary sections referenced in the feedback. As output, the terminal provides a combined view of summaries, answers, and feedback to the user, enabling an integrated learning experience.

### Step 17:

Server updates logs and model-interaction statistics as input for future optimization and stores updated performance indicators as output.

Server tracks each interaction with the generative AI model, including prompt length, response time, and error occurrences, as input to a logging subsystem. Server aggregates these records to compute performance indicators such as average latency per instructional unit, cache hit ratios for summaries, and distribution of emotion states. Server performs data processing by writing aggregated statistics to dedicated monitoring tables or log files. As output, the server maintains up-to-date metrics that can be used to adjust segmentation thresholds, prompt construction rules, or model parameters to improve processing speed, accuracy, and communication efficiency.

It is also possible to incorporate an emotion engine for estimating the user's emotions. That is, the specific processing unit 290 may estimate the user's emotions using an emotion identification model 59, and perform specific processing based on the estimated emotions.

### Example 2

Description follows regarding a flow of the specific processing in an Example 2. The units of the system described below are implemented by the data processing device 12 and the smart device 14. The data processing device 12 is called a “server” and the smart device 14 is called a “terminal”.

In contemporary educational environments, digital learning systems increasingly rely on computer-implemented delivery of text, audio, and video content. However, conventional systems are typically designed as loosely coupled toolchains in which text processing, question answering, text-to-speech conversion, avatar generation, and media streaming are implemented as separate, manually orchestrated components. In such architectures, human operators often must repeatedly export and import files between applications, manually configure speech synthesis parameters, and separately render and upload video files. This fragmented workflow leads to substantial latency, operator error, and inconsistency in educational content, and does not scale efficiently when large volumes of lessons and learner interactions must be processed.

Moreover, many existing systems focus primarily on converting static textual materials into audio or video without tightly integrating generative AI models and prompt control into the end-to-end media generation pipeline. For example, when a learner submits a question, conventional question-answering modules may generate text responses that are not automatically transformed into synchronized audio and avatar video, thereby forcing learners to consume heterogeneous media formats and limiting accessibility for users who benefit from multimodal explanations.

Furthermore, conventional systems generally do not control prompt sentences to generative AI models in a manner that is context-sensitive to both the underlying educational source content and the learner's emotional state. As a result, responses generated by the models may be overly long, too difficult, or insufficiently empathetic, and cannot be easily optimized for a learner's comprehension level, available learning time, or current affective condition. This lack of integrated prompt management prevents the system from systematically improving the quality, consistency, and personalization of generated educational materials. In addition, the media generation process in conventional systems is often decoupled from the streaming infrastructure. Video encoding, bitrate adaptation, and distribution are typically handled by external services without awareness of how the content was generated or how it will be adaptively consumed. This separation can result in inefficient resource utilization, sub-optimal encoding profiles for educational avatar videos, and poor responsiveness when learners request on-demand explanation videos generated from their individual questions. Accordingly, there is a need for an improved computer-implemented system and server-side processing architecture that: (i) integrates natural language processing, generative AI models with prompt sentences, speech synthesis, virtual character generation, and adaptive streaming into a unified pipeline; (ii) automatically converts educational source content and learner questions into narration scripts, audio data, and avatar-based educational videos; (iii) dynamically controls prompt sentences based on educational context and learner emotion analysis; and (iv) reduces computational overhead and processing latency while improving the consistency, clarity, and personalization of generated educational content. Such a system would represent a technical improvement to computer-implemented educational content delivery, media processing, and AI-assisted interaction, rather than a mere automation of human teaching activity.

The specific processing by the specific processing unit 290 of the data processing device 12 in Example 2 is realized by the following means.

The present invention provides a server comprising a processor configured to analyze content of an educational information medium by using a natural language processing function, to extract important information from the content for each educational unit, and to generate summary information; to provide a generative AI model with a prompt sentence including the summary information or educational text information as input, and to generate, based on the generative AI model, narration text information for learners or question-answer text information; to convert the narration text information into audio data by using a speech synthesis function and to generate an audio file while controlling a speaker attribute or a speaking style; to generate a virtual character video by using a virtual character generation function, the virtual character video having lip-sync motion and facial motion synchronized with the audio data, and to generate educational video data by combining the virtual character video with background video or explanatory text information; to encode the educational video data in a plurality of image qualities or bit rates, to convert the encoded data into a distribution data format, to store the converted data, and to make the converted data streamable to a learner terminal via a network; to dynamically generate a prompt sentence for the generative AI model based on a question sentence acquired from a learner and content of a related educational information medium, to generate answer text information for the question based on the prompt sentence, and, when necessary, to generate answer educational video data by using the speech synthesis function and the virtual character generation function; and to acquire emotion information of the learner by using an emotion analysis function that estimates an emotional state of the learner, and to change a representation style of the prompt sentence provided to the generative AI model or feedback content according to the emotion information. This enables an integrated and technically improved server-side processing pipeline in which educational text content and learner questions are automatically transformed into context-appropriate narration scripts, synchronized audio, and avatar-based educational videos, while adaptive control of prompt sentences and media encoding reduces processing latency, improves the quality and personalization of generated outputs, and enhances the efficiency and responsiveness of computer-implemented educational content delivery.

The term “system” refers to an arrangement of one or more computing devices, storage devices, communication interfaces, and software components that cooperate to execute the functions described in the claims.

The term “processor” refers to one or more hardware processing units, such as a central processing unit, a graphics processing unit, or a dedicated accelerator, that execute machine-readable instructions to perform the operations described herein.

The term “educational information medium” refers to any physical or electronic medium that stores educational content, including but not limited to printed books, electronic documents, web pages, slide files, and other digital learning materials.

The term “content” refers to information contained in an educational information medium, including text, headings, annotations, and other instructional elements that are to be processed by the system.

The term “educational unit” refers to a logically grouped portion of educational content, such as a lesson, a topic, a chapter section, or a learning module, that is treated as a discrete unit for processing and delivery.

The term “summary information” refers to condensed text or data that captures essential points of educational content or an educational unit while omitting less important details.

The term “natural language processing function” refers to a software-implemented capability that analyzes, interprets, or transforms natural language text, including operations such as tokenization, parsing, semantic analysis, summarization, and classification.

The term “generative AI model” refers to a machine learning model that generates text or other data outputs in response to input data, including models based on neural networks, language models, or other generative architectures.

The term “prompt sentence” refers to text or structured input data provided to a generative AI model to specify a task, constrain an output style, supply context, or otherwise guide the behavior of the generative AI model.

The term “educational text information” refers to text data derived from educational content, including full passages, selected excerpts, or reformulated explanations intended for use in teaching or learning.

The term “narration text information” refers to text that is prepared or formatted for spoken presentation in an educational audio or video, including summaries, explanations, and instructional scripts.

The term “question-answer text information” refers to text that represents an answer generated in response to a learner's question, including explanations, clarifications, and examples.

The term “speech synthesis function” refers to a software-implemented capability that converts text into audio data representing synthetic speech.

The term “audio data” refers to digital information representing sound, including waveform samples, encoded audio streams, or audio files that can be played back as speech or other audio.

The term “audio file” refers to a digital file that stores audio data in a predefined format, such as an uncompressed or compressed audio format suitable for playback or further processing.

The term “speaker attribute” refers to one or more parameters that define characteristics of synthetic speech, including but not limited to gender, age, accent, speaking rate, pitch, and timbre.

The term “speaking style” refers to a set of prosodic and expressive characteristics of synthetic speech, such as formality, enthusiasm, calmness, or emphasis patterns.

The term “virtual character generation function” refers to a software-implemented capability that generates a graphical or animated representation of a character, avatar, or agent, including movements that can be synchronized with audio.

The term “virtual character video” refers to digital video data in which a generated virtual character appears and performs visual actions, including lip movements and facial expressions.

The term “lip-sync motion” refers to animation of a virtual character's mouth and related facial regions in temporal alignment with phonemes or syllables in an audio signal.

The term “facial motion” refers to animation of facial features of a virtual character, including movements of eyes, eyebrows, cheeks, and other facial elements that convey expression or emphasis.

The term “background video” refers to image or video data that is displayed behind a virtual character, including static backgrounds, animated scenes, or presentation slides.

The term “explanatory text information” refers to text elements presented visually in a video, such as titles, subtitles, bullet points, formulas, or captions that aid understanding of the educational content.

The term “educational video data” refers to digital video information that presents educational content, including audio, virtual character animation, and any background or explanatory text combined into a media stream or file.

The term “image quality” refers to one or more attributes of video data, including resolution, compression parameters, and visual fidelity as perceived during playback.

The term “bit rate” refers to the amount of data used to represent audio or video per unit time, typically expressed in bits per second, which affects quality and transmission requirements.

The term “distribution data format” refers to a file or stream format suitable for delivering media over a network, including container formats, codec configurations, and streaming segment structures.

The term “learner terminal” refers to an electronic device used by a learner to access content over a network, such as a personal computer, tablet, smartphone, or other computing device.

The term “network” refers to a communication infrastructure that enables data transfer between computing devices, including wired or wireless local area networks and wide area networks such as the Internet.

The term “question sentence” refers to text provided by a learner that expresses a question or inquiry regarding educational content.

The term “answer educational video data” refers to educational video data generated specifically to present an answer to a learner's question, including synthesized speech and virtual character animation.

The term “emotion information” refers to data representing an inferred emotional state or affective condition of a learner, such as engagement, confusion, frustration, or confidence.

The term “emotion analysis function” refers to a software-implemented capability that estimates a learner's emotional state based on input data, such as text, audio, image, or interaction patterns.

The term “feedback content” refers to information provided to a learner in response to performance, behavior, or state, including encouragement, corrective explanations, recommendations, or adaptive guidance.

The term “representation style” refers to stylistic characteristics of text or speech, such as tone, complexity, politeness level, level of detail, or degree of formality, as controlled by the system.

The term “summary generation” refers to the process of creating summary information from more detailed content by selecting and condensing key information.

The term “media encoding” refers to the process of converting raw audio or video data into a compressed or otherwise formatted representation suitable for storage or transmission.

The term “streamable” refers to a property of data that allows it to be transmitted and consumed progressively over a network without requiring prior download of an entire file.

The term “adaptive streaming” refers to a media delivery technique in which multiple encoded versions of the same content at different bit rates or resolutions are provided, and a client dynamically selects among them based on network conditions or device capabilities.

The term “context information” refers to data related to the educational situation in which content is generated or delivered, including the source educational content, the learner's progress, and associated metadata used to construct prompt sentences.

The term “metadata” refers to descriptive data associated with educational content or media files, including identifiers, titles, subject labels, timestamps, durations, and configuration parameters.

The term “automatic conversion” refers to computer-implemented transformation of data from one form to another without requiring manual intervention for each instance.

In one embodiment, a server, a plurality of terminals, and a communication network together implement the system. The server includes at least one processor, a main memory, a non-volatile storage device such as a solid-state drive, and a network interface controller. The terminals include general-purpose computing devices such as personal computers, tablet devices, and smartphones, each having a display, an input device such as a keyboard or touch panel, local storage, and a network interface. The network includes wired or wireless communication infrastructure that supports packet-based protocols such as TCP/IP and HTTPS.

The server executes a server-side operating system such as a UNIX-compatible operating system, and the terminals execute client-side operating systems such as a desktop operating system or a mobile operating system. The server executes application software that is implemented, for example, using a web server framework and an application framework. The terminals execute a web browser or a dedicated learning application. The server and the terminals cooperate to implement the data flows and control flows described below. The user uses a terminal to author educational text content that is derived from an educational information medium such as a printed textbook or an electronic learning document. The user operates a word processing application such as a general-purpose word processor or a text editor on the terminal, and inputs explanatory sentences, headings, and examples. The terminal stores this educational text content in a local file with a structured format such as a markup-based document format or a plain text format. The user then operates a browser on the terminal to access a web interface provided by the server and uploads the file. The terminal sends the file as multipart form data in an HTTPS POST request, and the server receives and stores the file in non-volatile storage.

The server parses the uploaded file and extracts plain text. The server uses a document parsing library that supports the specific file formats, and the server normalizes the text into a unified character encoding, removes control characters, and converts heading markers into a standardized internal notation. The server stores the normalized text in a relational database system along with metadata such as subject category, difficulty level, and estimated reading time. The server represents each educational content item as a record that includes fields for content identifier, raw text, normalized text, topic labels, and version information.

The server applies a natural language processing function to the normalized text to divide the content into educational units and to generate summary information. The server executes a text segmentation pipeline implemented using a natural language processing library such as a statistical or neural language processing framework. The server tokenizes the text into sentences and paragraphs and generates an intermediate data structure that contains sentence boundaries, paragraph boundaries, and syntactic annotations. The server uses rule-based heuristics and learned classifiers to detect section headings, list structures, and question-answer patterns. The server assigns each sentence to a candidate educational unit by clustering sentences based on semantic similarity and heading structure. The server therefore produces an internal representation in which each educational unit is associated with a list of sentence identifiers, topic labels, and a unit title.

The server uses a generative AI model to generate summary information and narration text information for each educational unit. In one implementation, the generative AI model is a transformer-based neural language model that contains multiple self-attention layers, feed-forward layers, and layer normalization components. The server stores the parameters of the generative AI model in non-volatile storage and loads them into memory as needed. The server provides input to the generative AI model in the form of a prompt sentence concatenated with the text of the educational unit. The server constructs the prompt sentence so as to control the behavior of the model. For example, the server generates a prompt sentence such as:

“Summarize the following educational text into a concise explanation for high-school students, preserving key technical terms and limiting the length to approximately 200 words: [unit text].”

The server encodes the prompt sentence and the unit text into token sequences using a subword tokenizer associated with the model, and supplies the token sequence to the model.

The model executes a series of matrix multiplications and non-linear transformations that implement self-attention and feed-forward operations. The server obtains the output token probabilities from the model, selects tokens using a decoding algorithm such as beam search or nucleus sampling with predefined parameters, and assembles the tokens into an output string. In this way, the server generates summary information and narration text information for each educational unit.

The server may further refine the narration text information by invoking the generative AI model with additional prompt sentences that specify style or length constraints. For example, the server may provide a prompt sentence such as:

“Rewrite the following explanation in a friendly and engaging tone suitable for a 10-minute video narration, without changing the core facts: [summary text].”

The server performs an iterative refinement, measuring the length and syntactic complexity of the generated text using the natural language processing function, and repeating the generation with adjusted prompt sentences until the text falls within target ranges for length and readability. By performing this optimization algorithmically, the server improves consistency relative to ad hoc human editing and reduces variability in narration quality.

The server converts the narration text information into audio data using a speech synthesis function. In one embodiment, the speech synthesis function is implemented by a neural text-to-speech engine that includes an encoder-decoder architecture such as a sequence-to-sequence model with attention. The server supplies the narration text as input and sets speaker attributes such as gender, accent, and speaking style via parameters. The server encodes the text into phoneme sequences and prosodic features, and the model generates mel-spectrograms, which are then converted to waveform audio via a vocoder network such as a convolutional or autoregressive model. The server stores the resulting audio data in an audio file with a specified sampling rate and bit depth. The server associates the file path and metadata such as duration and speaker attributes with the corresponding educational unit record in the database.

The server generates a virtual character video using a virtual character generation function. In one embodiment, the server employs a character animation engine implemented in a graphics engine. The server selects an avatar configuration that includes facial mesh data, skeletal rig data, texture information, and clothing parameters. The server then synchronizes the avatar's lip and facial motions to the audio data. The server analyzes the audio file to derive phoneme alignment and energy contours using a phoneme recognizer and a prosody analyzer. The server maps each phoneme to a set of viseme parameters that define the shape of the avatar's mouth. The server interpolates these viseme parameters over time to create continuous lip-sync motion, and additionally applies rules that map prosodic emphasis and pitch changes to facial expressions such as eyebrow movement and head nods. The server renders the virtual character against a background video or a static background image and overlays explanatory text information such as titles and bullet points using a text rendering engine.

The server encodes the rendered frames and audio into an educational video data stream using a video codec and an audio codec.

The server optimizes network delivery by encoding each educational video data stream into multiple bit rates and resolutions. The server uses a media encoding library or tool to transcode the original high-quality video into variants such as low, medium, and high bit rates. The server segments the video into short chunks and generates manifest files according to an adaptive streaming protocol. The server stores the video segments and manifest files in a content storage system and configures a streaming server to deliver the segments. By precomputing multiple bit rate variants and generating manifest files, the server enables terminals to adaptively select an appropriate stream according to measured network conditions and device capabilities, which reduces buffering and optimizes bandwidth utilization.

The learner uses a terminal to access the educational content. The terminal sends a request to the server for a list of educational units associated with a course. The server queries the database and returns a structured response that includes unit titles, level metadata, and thumbnail images. The terminal displays the list and enables the learner to select a unit. When the learner selects a unit, the terminal requests the corresponding educational video stream using the manifest URL. The streaming server delivers video chunks, and the terminal decodes the chunks using a media playback module. The terminal displays the virtual character video and plays the audio through a speaker or headphones. The integration of the encoding, storage, and streaming functions with the generation pipeline enables reduced end-to-end latency and avoids manual transfer between disparate systems.

The learner may submit questions regarding the educational content by entering text into an input field displayed on the terminal. The terminal sends the question sentence and the identifier of the related educational unit to the server. The server retrieves the original text and summary information for the unit from the database and constructs a prompt sentence that includes both the lesson context and the question. For example, the server may generate a prompt sentence such as:

“You are a teacher. Answer the following student question based on this lesson text. Use clear, simple language and include one concrete example: [lesson text] Student question: [question].”

The server tokenizes this prompt sentence and context and feeds them into the generative AI model. The model outputs answer text information, and the server analyzes the output length, vocabulary level, and sentence structure. If the answer does not meet predefined criteria, the server generates another prompt sentence that imposes additional constraints, such as limiting the number of sentences or requiring a specific pedagogical structure. This control loop leads to more consistent answer quality and reduces the risk of overly complex or off-topic responses.

The server may convert the answer text information into audio and a virtual character video in the same manner as for the main narration. The server therefore generates answer educational video data that explains the response in a multimodal format. The terminal receives the answer educational video data or a streaming URL and presents a “Play Explanation” control that allows the learner to watch an avatar delivering the answer with synchronized speech and accompanying text. This enables learners with different learning preferences or accessibility needs to receive tailored explanations.

The server further uses an emotion analysis function to estimate the learner's emotional state and to adjust the behavior of the generative AI model and the feedback. The server obtains input signals such as camera images, microphone input, or interaction logs from the terminal, subject to privacy and consent constraints. In one embodiment, the server analyzes facial expressions in captured images using a convolutional neural network trained to classify affective states such as confusion, frustration, or engagement. In another embodiment, the server analyzes text typed by the learner for sentiment and emotional indicators using a language model. The server produces emotion information represented as a vector of scores or categorical labels, and stores this information in association with the learner's session. When generating prompt sentences for the generative AI model, the server modifies the representation style based on the emotion information. For instance, if the emotion analysis function detects confusion, the server may include instructions in the prompt sentence to slow down the explanation, use simpler vocabulary, and provide additional examples. By explicitly encoding emotion-based instructions into the prompt sentence, the server guides the model to produce content that is adapted to the learner's current state.

From a technical standpoint, the server improves computer functionality by integrating natural language processing, neural generative modeling, neural text-to-speech, and avatar rendering into a coordinated pipeline that is optimized for educational content generation.

The server uses structured data representations for educational units, summaries, narration scripts, audio files, and video assets, and maintains explicit linkage among these artifacts in the database. The server's scheduling and caching logic reduces redundant computations: for example, when the same educational unit is requested by multiple learners with similar preferences, the server can reuse previously generated audio and video files instead of regenerating them. This reduces computation time and energy consumption.

The system further improves computational efficiency by controlling generation length and complexity via prompt design and post-generation analysis, thereby constraining the search space during decoding of the generative AI model. The server can maintain per-course or per-topic parameters that specify maximum token counts and style constraints, which leads to faster generation and reduced memory usage. On the media side, the server avoids unnecessary high-bit-rate streaming by using adaptive streaming and by precomputing bitrate-optimized variants, which reduces network congestion and improves playback stability.

The generative AI model in the server is trained or fine-tuned using a specific training procedure. The server or an associated training system initializes the model weights, defines a loss function such as a cross-entropy loss over next-token prediction, and applies gradient-based optimization. The training data includes pairs of input prompt sentences and target outputs such as high-quality summaries and pedagogical explanations. Data augmentation methods may be applied, such as paraphrasing, noise injection, and back-translation, to improve robustness and reduce overfitting. During training, the system adjusts learning rates and applies regularization techniques such as dropout. This training process results in a model that is specialized for educational summarization and explanation tasks, thereby improving accuracy and reducing errors relative to general-purpose models. The text-to-speech component may be trained or configured to support domain-specific pronunciation and prosody. The server may maintain a lexicon of subject-specific terms and their pronunciations, and a prosody rule set for emphasizing definitions and key formulas. When generating audio, the server consults this lexicon and inserts phonetic annotations into the text before passing it to the speech synthesis function. This reduces mispronunciations and improves intelligibility in technical domains.

The virtual character generation component uses a predefined mapping between phoneme sequences and viseme configurations, and may further employ a learned model that predicts viseme sequences from mel-spectrograms. The server stores a rigging configuration that includes bone hierarchies and blend shape definitions for facial components. By using this rigging configuration, the server can compute efficient transformations that drive avatar motions, and can share computation across different avatars by reusing generic motion curves. This reduces the computational cost of rendering and enables real-time or near-real-time generation of short answer videos.

In a variation, the server may operate with multiple generative AI models, each specialized for a different function (for example, one model for summarization, one model for dialogue, one model for style adaptation). The server selects an appropriate model according to metadata and prompt content. The server may also deploy alternative architectures such as recurrent neural networks or convolutional sequence models for lower-resource environments. In another variation, the emotion analysis function may rely solely on interaction patterns such as response times and error rates, rather than on camera or microphone input, in order to reduce hardware requirements and preserve privacy.

The terminal may implement additional features to optimize resource usage. For example, the terminal can cache frequently accessed manifests and media segments, and can dynamically adjust playback quality based on instantaneous network throughput measurements. The terminal may also prefetch small answer videos based on predicted questions, using hints provided by the server. These operations reduce latency and improve user experience. By implementing these specific data structures, algorithms, and hardware-software interactions, the system goes beyond mere automation of human teaching tasks. The server achieves technical improvements in processing speed by reducing redundant generative operations and optimizing media encoding; improves accuracy and consistency by controlling prompt sentences, training specialized models, and applying rule-based validation; and reduces communication overhead by employing adaptive streaming and selective regeneration. The described integration of natural language understanding, generative AI modeling, speech synthesis, avatar control, and network-optimized media delivery yields a technical solution that enhances the operation of the underlying computer systems themselves.

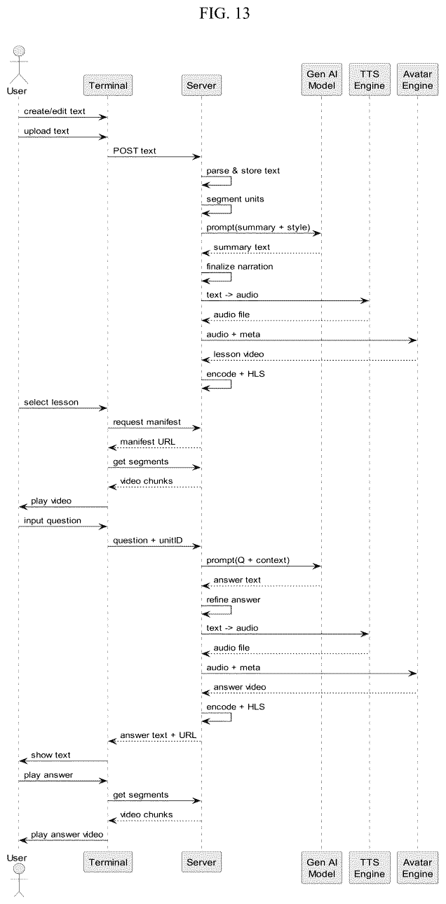

The following describes the processing flow using FIG. 13.

### Step 1:

The user uses a terminal to create educational text content. The input is raw educational knowledge from an educational information medium such as a textbook or a digital document. The user operates a word processor or text editor on the terminal to type or paste explanations, headings, and examples, and the terminal stores this content as a text file in local storage. The output is a structured document file containing educational text information.

The user uses the terminal to upload the educational text file to the server. The input is the locally stored document file. The user opens a browser or learning application, selects the file via a file-selection dialog, and initiates an upload operation. The terminal reads the file bytes, encapsulates them in an HTTPS POST request, and sends the request to the server. The output is transmitted file data received by the server.

### Step 3:

The server receives and parses the uploaded document file. The input is the raw file data sent from the terminal. The server invokes a document parsing module to extract plain text, convert character encoding, remove control characters, and normalize line breaks. The server performs data conversion from document format structures to a normalized text string. The output is normalized educational text information stored as a record in a database together with metadata such as content ID and subject category.

### Step 4:

The server performs text segmentation and educational unit detection. The input is the normalized educational text associated with a content ID. The server applies a natural language processing function to tokenize the text into sentences, identify paragraph boundaries, and detect heading patterns using rule-based and statistical methods. The server groups related sentences into clusters based on heading hierarchy and semantic similarity scores computed from word embeddings or contextual representations. The output is a set of educational units, each represented by a unit ID, a list of sentence indexes, and a tentative unit title.

### Step 5:

The server generates summary information for each educational unit using a generative AI model. The input is the text content of a specific educational unit. The server constructs a prompt sentence such as “Summarize the following educational text into a concise explanation for high-school students, preserving key technical terms and limiting the length to approximately 200 words: [unit text].” and concatenates this prompt sentence with the unit text. The server tokenizes the combined string, feeds the token sequence into a transformer-based generative AI model, and executes attention and feed-forward computations to predict output tokens. The output is summary information for that educational unit, encoded as a summary text string.

### Step 6:

The server refines narration text information based on style constraints. The input is the summary text generated in Step 5. The server evaluates text length, readability indices, and presence of required elements (for example, definitions or examples) using a natural language processing function. If constraints are not satisfied, the server constructs a new prompt sentence such as “Rewrite the following explanation in a friendly and engaging tone suitable for a 10-minute video narration, without changing the core facts: [summary text].” and again invokes the generative AI model. The server iterates this process until the generated text meets predefined thresholds. The output is finalized narration text information ready for speech synthesis.

### Step 7:

The server prepares voice parameters and phonetic annotations for speech synthesis. The input is the finalized narration text and associated metadata such as language and learner level. The server selects speaker attributes (gender, accent, age tone) and speaking style (formal, friendly, slow, etc.), and, when necessary, consults a pronunciation lexicon to annotate domain-specific terms with phonetic transcriptions. The server inserts markup or tags indicating pauses, emphasis, and pronunciation guides into the narration text. The output is an enriched narration script that includes both text content and speech control parameters.

### Step 8:

The server generates synthetic speech from the narration script. The input is the enriched narration script prepared in Step 7. The server calls a speech synthesis function implemented by a text-to-speech engine, which encodes the text into phoneme sequences, predicts prosodic features, and synthesizes a waveform using a neural vocoder. The server specifies output format parameters such as sampling rate and bit depth. The server receives the generated waveform samples and writes them to an audio file in a format such as WAV or MP3. The output is an audio file containing narration audio data linked to the educational unit.

### Step 9:

The server analyzes the generated audio to produce alignment data for animation. The input is the narration audio file generated in Step 8. The server executes an audio analysis module that applies phoneme recognition and prosody extraction to determine phoneme boundaries, intensity, and pitch contours. The server converts this information into a time-aligned sequence of phoneme labels and prosodic features, storing them as alignment data. The output is a phoneme-time alignment structure used to drive virtual character animation.

### Step 10:

The server configures a virtual character and background for the educational video. The input is the educational unit metadata, including subject, target age, and style settings. The server selects an avatar template (for example, teacher-like or assistant-like) and corresponding mesh, rig, and texture definitions from an avatar library. The server also selects a background (for example, classroom, neutral color, or slide image) and layout parameters for explanatory text overlays. The output is a virtual character configuration and scene configuration that specify visual parameters for rendering.

### Step 11:

The server generates virtual character animation synchronized with the audio. The input is the virtual character configuration from Step 10 and the phoneme-time alignment data from Step 9. The server maps each phoneme label to viseme parameters stored in a viseme mapping table. The server interpolates these parameters over time using a keyframe generator to create smooth lip-sync motion curves. The server also applies rules or a learned model that maps prosody features to facial expressions and head movements. The output is a sequence of animation curves or keyframes representing lip-sync and facial motion synchronized to the audio timeline.

### Step 12:

The server renders educational video frames combining the avatar, background, and explanatory text. The input is the animation curves from Step 11, the avatar and background configurations from Step 10, and the narration audio file from Step 8. The server uses a graphics rendering engine to compute 2D or 3D frames by applying the animation curves to the virtual character rig, compositing the character onto the background, and overlaying on-screen explanatory text such as titles and bullet points. The server synchronizes frame timestamps with the audio timeline to ensure consistent playback. The output is a sequence of raw video frames and associated audio ready for encoding.

### Step 13:

The server encodes the rendered video and audio into multiple bit rates. The input is the raw video frames and audio from Step 12. The server invokes a media encoding module to compress the video using a video codec and compress the audio using an audio codec, producing a high-quality master file. The server then transcodes the master file into several variants with different resolutions and bit rates, calculating appropriate encoding parameters to balance quality and bandwidth. The output is a set of encoded educational video data files at multiple quality levels.

### Step 14:

The server prepares adaptive streaming assets for network delivery. The input is the set of encoded video files from Step 13. The server segments each file into short chunks, for example, a few seconds per segment, and generates manifest files conforming to an adaptive streaming protocol. The server writes the segments and manifests to a content storage system and registers their locations in a database with references to the corresponding educational unit. The output is a set of segment files and manifest files that can be requested by learner terminals for streaming playback.

### Step 15:

The terminal requests and plays back an educational video. The input is a user selection of an educational unit on the terminal interface. The terminal sends a request for playback information to the server, receives the URL of the manifest file, and initializes a media player. The terminal downloads manifest and segment files, measures network throughput, and dynamically selects appropriate bit-rate segments based on available bandwidth and device capabilities. The terminal decodes the selected segments to reconstruct video frames and audio samples, and displays the avatar video on the screen while outputting audio through speakers or headphones. The output is rendered multimedia playback presented to the learner.

### Step 16:

The learner submits a question about the educational content. The input is a question sentence typed by the learner on the terminal and the identifier of the relevant educational unit. The terminal encapsulates the question sentence and unit ID in a structured request and sends it to the server. The terminal may also record context such as the playback timestamp at which the learner paused the video. The output is a question request delivered to the server.

### Step 17:

The server constructs a context-rich prompt sentence for answer generation. The input is the learner's question sentence, the associated educational unit ID, and the original unit text and summary information retrieved from the database. The server concatenates the lesson context and question into a prompt sentence such as “You are a teacher. Answer the following student question based on this lesson text. Use clear, simple language and include one concrete example: [lesson text] Student question: [question].” The server tokenizes this prompt sentence and stores the token sequence as the model input. The output is a prepared model input that encodes both educational context and learner question.

### Step 18:

The server generates answer text information using the generative AI model. The input is the tokenized prompt sentence from Step 17. The server feeds the tokens into the transformer-based generative AI model, which applies self-attention, feed-forward transformations, and softmax operations to compute probability distributions over output tokens. The server decodes the output tokens using a constrained decoding method that limits maximum tokens and discourages repetition. The server then joins the tokens into an answer text string. The output is answer text information that addresses the learner's question with an explanation and an example.

### Step 19:

The server validates and refines the generated answer text. The input is the answer text from Step 18. The server uses a natural language processing function to measure answer length, complexity, and relevance to the question by comparing key terms from the answer with terms in the original lesson text and question. If the answer exceeds length thresholds or lacks required structural elements, the server generates an additional prompt sentence such as “Rewrite the previous answer in about 150 words and include one concrete numeric example.” and re-invokes the generative AI model. The server repeats this adjustment until the answer conforms to predefined criteria. The output is a finalized answer text with controlled length and structure.

### Step 20:

The server converts the answer text into answer educational audio and video. The input is the finalized answer text from Step 19 and the same or similar avatar and background configuration used for the main lesson. The server performs the same sequence of operations as in Steps 7 through 12: generating enriched narration scripts, synthesizing audio, creating phoneme-time alignments, constructing avatar animation curves, and rendering video frames with explanatory overlays. The server may shorten or simplify background elements to match the shorter answer format. The output is an answer educational video data set that explains the answer in audio-visual form.

### Step 21:

The server updates streaming assets and provides access to the answer educational video. The input is the answer educational video data generated in Step 20. The server encodes and segments the video (similar to Steps 13 and 14), stores the resulting segments and manifest in content storage, and records their identifiers in association with the question and learner session. The server returns a manifest URL or direct streaming URL to the terminal. The output is a playable answer video resource linked to the learner's question.

### Step 22:

The terminal presents the answer text and optional answer video to the learner. The input is the answer text and streaming URL received from the server. The terminal displays the text answer in the user interface and provides a control element such as a “Play Explanation” button. When the learner activates this control, the terminal requests and streams the answer educational video, decodes the segments, and plays the avatar explanation synchronized with audio. The output is an interactive response presentation that combines textual and audiovisual feedback.

### Step 23:

The server acquires emotion information and adapts prompt sentences accordingly. The input is interaction data from the terminal and, in some embodiments, sensor data such as camera images or microphone audio. The server applies an emotion analysis function, which may include a convolutional neural network for facial expression classification or a sentiment classifier for learner text, to compute probabilities for emotional states such as confusion or frustration. The server converts these probabilities into emotion information associated with the learner session. The server then modifies subsequent prompt sentences for the generative AI model by inserting instructions that adjust tone, complexity, and pace, for example, specifying more step-by-step explanations or reassurance phrases when confusion is detected. The output is a set of context- and emotion-aware prompt sentences that guide future generations.

### Step 24:

The server maintains and optimizes data structures for reuse and efficiency. The input is the various artifacts produced in previous steps, including unit segmentation data, summaries, narration scripts, audio files, video files, and emotion profiles. The server organizes these artifacts in a relational database and content storage system with indices that reference educational unit IDs, learner IDs, and context tags. The server uses caching strategies to detect when a requested combination of unit, style, and emotion parameters has already been processed, in which case the server retrieves existing media instead of recomputing it. The output is reduced computation load and faster response times due to reuse of previously generated results.

### Application Example 2

Description follows regarding a flow of the specific processing in an Application Example 2. The units of the system described below are implemented by the data processing device 12 and the smart device 14. The data processing device 12 is called a “server” and the smart device 14 is called a “terminal”.

Conventional computer-implemented learning support systems typically treat natural language processing, multimedia generation, and user modeling as separate, loosely coupled components. A content authoring tool may generate static summaries from digital documents; a separate media pipeline may convert prepared scripts into audio or video; and an independent analytics module may approximate learner performance based on coarse usage statistics. Such fragmented architectures suffer from several technical limitations. First, existing systems generally do not use a unified control flow in which a processor programmatically orchestrates a generative AI model with explicit prompt sentences as first-class control parameters. As a result, content generation (summarization, explanation, and assignment creation) often relies on fixed templates or rule-based engines that cannot adapt the difficulty, structure, and style of generated outputs to fine-grained, machine-readable metadata such as learning-unit segmentation, target understanding levels, and evolving learner profiles. This leads to inefficient use of compute resources and repetitive API calls, because the system cannot precisely constrain or reuse generative computation based on structured control data.

Second, conventional systems do not tightly integrate emotion estimation into their core natural language processing pipeline. Sentiment or emotion analysis, if present at all, is often carried out as a post-processing step that does not feed back into the generative algorithms driving explanations and feedback. Consequently, the system cannot automatically adjust explanation style, feedback tone, or assignment design at generation time based on real-time emotion signals computed from learner text and history. This results in technically suboptimal utilization of emotional context: the same generative output is returned regardless of whether the learner is confused, frustrated, or confident, which reduces the effectiveness of adaptive generation logic and wastes the potential of emotion models.

Third, many existing e-learning architectures handle multimedia generation and delivery in a batch-oriented or manually curated manner. A processor may trigger speech synthesis or avatar rendering, but this is often decoupled from the upstream generative AI logic that created the script and from the downstream logging of interactions. The system fails to maintain a consistent machine-tractable linkage between (i) prompt sentences, (ii) generative outputs (summaries, scripts, answers, assignments), (iii) derived audio and video artifacts, and (iv) learner interaction and progress logs. This lack of end-to-end linkage impairs the ability of the system to compute accurate progress metrics, to reuse existing generative outputs efficiently, and to optimize subsequent prompts and model calls. In effect, the computer system cannot exploit the full feedback loop between generation, delivery, interaction, and model adaptation, resulting in suboptimal performance and scalability. Fourth, known systems typically treat questions, assignments, and feedback as separate content types, processed by distinct modules or workflows. They lack a processor-controlled mechanism to normalize all of these artifacts into a single generative AI pipeline orchestrated through prompt sentences that explicitly encode task type (e.g., answer generation, assignment generation, feedback refinement), learner state (history and progress), and emotion state. Without such a unified orchestration, it is difficult to maintain coherent personalization and to reduce redundant computation; the system may repeatedly re-derive similar content or may be unable to systematically exploit shared model context, thereby increasing latency and resource consumption.

Accordingly, there is a need for an improved computer-implemented educational support system in which a processor centrally orchestrates a generative AI model, a natural language processing function, a speech synthesis function, a virtual character generation function, and an emotion estimation function. The processor should be able to generate, via prompt sentences, machine-constrained outputs such as learning-unit summaries, oral explanation scripts, personalized answers, individualized assignments, and emotion-adaptive feedback, while maintaining structured associations among generated artifacts, learner states, and multimedia outputs. By addressing these deficiencies, the invention aims to improve the functioning of the computer system itself, including the efficiency, adaptability, and technical coherence of end-to-end generation, emotion-aware adaptation, and delivery of instructional content.

The specific processing by the specific processing unit 290 of the data processing device 12 in Application Example 2 is realized by the following means.

The present invention provides a server comprising a processor configured to analyze text information of learning material by using a natural language processing function, to extract important information from the text information, and to generate summary information for each learning unit; to provide a generative AI model with input data including a prompt sentence that instructs the generative AI model to understand contents of the learning material and to structure the contents into the learning units, and to cause the generative AI model to generate, as output, the summary information and script information for oral explanation; to convert the script information for oral explanation into audio data by using a speech synthesis function; to generate video data in which a virtual character performs an explanation, by using a virtual character generation function on the basis of the audio data and the script information for oral explanation, and to distribute the video data to a terminal device via a communication network; to acquire question text of a learner and learning status data from the terminal device, to provide the generative AI model with input data including a prompt sentence that instructs the generative AI model to generate an answer and an assignment on the basis of the question text and the learning status data, and to cause the generative AI model to generate, as output, answer information to the question and assignment information individualized for the learner; to estimate an emotion state of the learner from at least one of the question text, assignment answer text, and learning history data by using an emotion estimation function, to generate an additional prompt sentence for modifying at least one of the answer information, the assignment information, and feedback information in accordance with the emotion state, to provide the generative AI model with the additional prompt sentence, and to cause the generative AI model to generate emotion-adaptive explanation information or feedback information; and to transmit the answer information, the assignment information, and the emotion-adaptive feedback information to the terminal device, and to record and update learning progress information. This enables the computer system to implement an integrated, processor-controlled pipeline in which prompt sentences act as structured control data for the generative AI model, thereby technically improving generation and reuse of educational content, enabling automatic and emotion-aware adaptation of explanations and assignments based on real-time learner state, and maintaining machine-tractable associations among learning material, generated scripts, multimedia outputs, and logged learner interactions to enhance efficiency, scalability, and personalization of the educational support system.

The term “processor” refers to one or more hardware processing units, such as a central processing unit, a graphics processing unit, or a specialized accelerator, and any associated control circuitry configured to execute instructions that implement the claimed functions.

The term “system” refers to a combination of at least one processor, one or more storage devices, one or more communication interfaces, and any software modules executed by the processor, collectively configured to perform the operations recited in the claims.

The term “natural language processing function” refers to a software-implemented processing capability that analyzes text data expressed in a human language to perform at least one of tokenization, syntactic parsing, semantic analysis, key phrase extraction, or summarization.

The term “learning material” refers to any digital content intended for educational use, including but not limited to electronic documents, text files, slides, or other machine-readable resources containing instructional information.

The term “text information” refers to data representing characters, words, sentences, or paragraphs in a human language, encoded in a machine-readable format suitable for processing by the processor.

The term “learning unit” refers to a logically delimited portion of the learning material corresponding to a smallest instructional segment, such as a topic, subtopic, or lesson segment, that is treated as a unit of instruction by the system.

The term “summary information” refers to text information that is shorter than corresponding source text and that captures essential points or concepts of the source text for a given learning unit.

The term “generative AI model” refers to a machine-learned model configured to generate output data, such as text, in response to input data, the model having been trained on example data and being executable by computing hardware to produce context-dependent outputs.

The term “prompt sentence” refers to text information provided as part of input data to the generative AI model, the text information explicitly instructing the generative AI model regarding a target task, desired output format, or constraints on generated content.

The term “script information for oral explanation” refers to text information generated by the processor that is formatted or phrased as if spoken aloud, and is suitable to be read by a synthesized voice or a virtual character to explain a learning unit.

The term “speech synthesis function” refers to a software-implemented capability that converts text information into audio data representing synthesized speech signals.

The term “audio data” refers to digital data representing acoustic waveforms, including encoded or compressed representations suitable for storage, transmission, and playback as sound.

The term “virtual character” refers to a computer-generated graphical representation of a human, animal, or other figure, whose appearance and movements can be controlled by software to visually present information.

The term “virtual character generation function” refers to a software-implemented capability that, based on at least audio data and script information, generates video data in which a virtual character appears and performs mouth movements, gestures, or other actions synchronized with the audio data.

The term “video data” refers to digital data representing a sequence of image frames, optionally combined with audio data, suitable for playback as moving images on a display device.

The term “communication network” refers to any wired or wireless data communication infrastructure, including local area networks, wide area networks, and packet-switched networks, capable of transporting data between the server and one or more terminal devices.

The term “terminal device” refers to an end-user computing apparatus, such as a smartphone, tablet, personal computer, or head-mounted display, configured to communicate with the server, present content to a learner, and send learner inputs to the server.

The term “question text” refers to text information representing a query, request for explanation, or other natural language input provided by a learner to the system.

The term “learning status data” refers to machine-readable data indicating a current or past learning state of a learner, including at least one of viewed content identifiers, completion percentages, timestamps, or performance indicators.

The term “answer information” refers to text information generated by the system that responds to question text from a learner, providing an explanation, solution, or clarification.

The term “assignment information” refers to text information that defines one or more practice tasks, exercises, or problems to be solved by a learner, including optional hints or reference answers.

The term “individualized for the learner” refers to being adapted in at least one of difficulty, topic selection, or presentation style based on learning status data or other learner-specific information.

The term “emotion estimation function” refers to a software-implemented capability that analyzes input data, such as text or interaction history, to infer an emotional state, such as confusion, frustration, or confidence, associated with a learner.

The term “emotion state” refers to a classification or numerical representation of a learner's affective condition, as inferred by the emotion estimation function from observed data.

The term “assignment answer text” refers to text information representing a learner's response or solution to an assignment generated by the system.

The term “learning history data” refers to accumulated records of a learner's interactions with the system over time, including at least one of accessed learning units, submitted assignments, scores, timestamps, and prior question texts.

The term “additional prompt sentence” refers to prompt text that is generated or modified by the processor based on an estimated emotion state and that is provided to the generative AI model to influence generation of explanation or feedback content.

The term “emotion-adaptive explanation information” refers to explanation text generated by the generative AI model in response to a prompt sentence that encodes an emotion state, the explanation text having a style, tone, or level of detail adjusted according to the emotion state.

The term “feedback information” refers to information generated by the system and presented to a learner concerning the learner's performance, behavior, or progress, including comments, scores, suggestions, or encouragement.

The term “emotion-adaptive feedback information” refers to feedback information whose content, tone, or emphasis is modified based on an estimated emotion state of the learner.

The term “learning progress information” refers to data that represents a current state of a learner's advancement through learning material and assignments, including completion indicators, performance metrics, and time-based progression, and that is updated in response to interactions with the system.

In one embodiment, a server implements the claimed system using one or more processors, a main memory, non-volatile storage, and a network interface. The server executes software modules including: a natural language processing (NLP) module, a generative AI module interface, a speech synthesis module, a virtual character generation interface, an emotion estimation module, a learning progress management module, and an API module for communication with one or more terminal devices.

Server uses commodity server hardware such as multi-core central processing units and, optionally, graphics processors for accelerating neural network inference. Server stores learning material, learner profiles, generated content, and logs in a structured database such as a relational database management system or a key-value data store. The database schema defines tables or collections for learning materials, segmented learning units, prompt sentences, generative outputs, audio and video artifacts, and learning status data.

Server implements the natural language processing function using a library such as a transformer-based model framework. In one example, server uses a pre-trained encoder model that takes tokenized text as input and outputs contextual embeddings. Server performs tokenization by mapping each text string into a sequence of integer token identifiers, using a subword vocabulary. Server then performs syntactic and semantic analysis to detect sentence boundaries, headings, and key phrases. Server aggregates token-level attention weights and sentence-level scores to identify important sentences, and composes these sentences into summary information for each learning unit.

Server implements the generative AI model interface as a module that constructs prompt sentences and passes encoded text to a generative sequence model. In one example, server uses a transformer-based decoder or encoder-decoder model comprising multiple self-attention layers, feed-forward networks, and layer normalization. Server supplies, as input, a concatenation of an instruction portion (the prompt sentence) and a content portion (e.g., source text or learner data). The model weights are obtained from offline training on large corpora via gradient-based optimization; during inference, server executes the forward pass only, computing attention scores, weighted sums, and non-linear transformations to generate output token distributions. Server selects output tokens using beam search or top-k sampling to balance determinism and diversity.

Server coordinates the generative AI model using prompt sentences encoded as structured control text. For example, server generates the following prompt sentence when creating structured learning units:

“Summarize the following textbook section into 2-3 concise educational units suitable for a 10-minute lesson each. Output a numbered list with clear, simple explanations.” Server passes this prompt sentence followed by the raw section text into the generative AI model. The model processes the combined input as a single token sequence and produces an output sequence that encodes summary information segmented into numbered units. Server parses this output by detecting numbering patterns and line breaks, separates it into independent learning units, and stores each unit in the database linked to the original material. Server refines each learning unit into script information for oral explanation by generating a second prompt sentence, for example:

“Rewrite the following educational unit as a friendly spoken explanation for a high-school student. Use short sentences and spoken style.”

Server concatenates this prompt sentence with the learning unit text and again executes the generative AI model. The model reorganizes sentences, simplifies wording, and adds connective phrases suited for spoken delivery. Server receives the generated script text, normalizes whitespace, and stores the script as script information for oral explanation.

Server implements the speech synthesis function using a text-to-speech (TTS) engine. Server converts each script into a phoneme sequence, applies a parametric or neural vocoder, and generates audio data. In one configuration, server uses a neural TTS model consisting of an encoder, attention-based alignment, and a decoder that outputs mel-spectrogram frames, followed by a vocoder that synthesizes waveform samples. Server configures voice characteristics, such as pitch and speed, through model parameters and TTS engine options. Server stores resulting audio files, such as compressed waveforms, in an object storage service and records references in the database.

Server provides the virtual character generation function through an external avatar or character rendering system. Server transmits the audio data and the script text to the character rendering system over a network interface. The character rendering system performs viseme prediction from the audio or the phoneme sequence and animates a virtual character rig to match mouth shapes and facial expressions to the audio timeline. Server receives video data (for example, in a streaming container format) from the character rendering system and stores the video data in storage accessible via a content delivery network. Server also records associations between script information, audio data, and video data in the database.

Terminal comprises a computing device, such as a smartphone, tablet, personal computer, or head-mounted display, connected to the server via a communication network. Terminal includes a display, loudspeakers or headphones, and input interfaces such as a touch screen or keyboard. Terminal executes a client application or web browser that communicates with server APIs to retrieve metadata, audio and video streams, and interactive content.

Terminal requests a list of available learning units by sending an HTTP or HTTPS request to server. Server responds with structured metadata including learning unit identifiers, titles, subject tags, difficulty levels, and video URLs. Terminal displays the list and allows a user to select a unit. Upon selection, terminal requests the corresponding video data and plays it back using a media player component that decodes compressed video frames and audio samples. Terminal may display synchronized captions generated from the script information for oral explanation.

User watches the video on terminal and, at any time, enters question text through an input field. User may type a question such as:

“I don't understand why the derivative represents a rate of change.”

Terminal transmits the question text together with context information, such as the learning unit identifier and the current playback position, to server. Server records the raw question text, associates it with the corresponding learning unit and learner identifier, and then prepares an instruction for the generative AI model.

Server constructs a problem-specific prompt sentence, for example:

“You are a tutor. The student is watching a lesson about basic derivatives. Explain the answer to the following question in a simple way. Use one or two concrete examples.” Server concatenates this prompt sentence and the learner's question text and feeds the combined sequence into the generative AI model. The model generates answer information that describes, step-by-step, why a derivative can be interpreted as a rate of change, possibly introducing simple numeric examples. Server parses the generated output, removes extraneous leading or trailing phrases if necessary, and stores the final answer text. Server additionally applies the emotion estimation function to the question text. In one embodiment, server uses a separate neural classifier with an architecture similar to a transformer encoder fine-tuned on labeled emotion data. Server tokenizes the question text, computes contextual embeddings, projects the sequence into a pooled representation, and feeds this representation into a classification layer whose outputs correspond to emotion labels such as “confused,” “curious,” or “frustrated.” Server computes a probability distribution using a softmax function and selects an emotion state based on a decision rule, such as selecting the label with maximum probability.

Server then decides whether to adjust the explanation style based on the estimated emotion state. If server determines that the learner is confused, server generates an additional prompt sentence such as:

“The student seems confused. Rewrite the following explanation to be even simpler, with step-by-step reasoning and reassurance, and avoid technical jargon.”

Server concatenates this additional prompt sentence with the initial answer information and passes the combined text to the generative AI model. The model outputs revised explanation information with shorter sentences, more intermediate steps, and explicit reassurance phrases. Server stores the emotion-adaptive explanation information as emotion-adaptive explanation information and returns it to terminal.

Terminal receives the answer information and, if present, the emotion-adaptive explanation information. Terminal renders the explanation text below or beside the playback interface, optionally with formatting such as bullet points or emphasis. Terminal may also request that server produce an audio or avatar-based version of the explanation by applying the speech synthesis function and virtual character generation function to the explanation text. In that case, terminal plays back a new short video clip where the virtual character answers the learner's question.

Server maintains learning status data and learning history data for each learner. Each time a learner watches a video, submits a question, receives answer information, or completes an assignment, server records an event in the database with timestamps, identifiers, and any associated metrics. Server periodically aggregates these events to compute learning progress information, such as completion percentages of learning units, distribution of topics studied, and performance scores on assignments.

When user requests additional practice, user may input a natural language request such as: “Give me some practice problems on this topic.”

Terminal transmits the request and the current learning status data to server. Server retrieves learning history data, including previously completed assignments, scores, and question patterns. Server summarizes this state, for example indicating that the learner understands computational procedures but struggles with conceptual understanding. Server then generates a prompt sentence like:

“Create 5 math problems about basic derivatives for a high-school student. The student understands the derivative formula but is confused about the idea of rate of change. Start with very simple, concrete examples and gradually increase difficulty. Provide correct answers and short hints.”

Server concatenates this prompt sentence with a concise description of the learner's previous performance and sends it to the generative AI model. The model outputs assignment information, including a list of problems, associated correct answers, and hints. Server parses the output into a structured assignment representation, assigning identifiers to each question, and stores the assignment in the database. Terminal retrieves and displays the assignment to user, who can then enter assignment answer text for each question.

Server receives the assignment answer text, loads the corresponding assignment information, and evaluates the answers. For objective items, server compares the answers to stored correct solutions. For open-ended answers, server constructs an evaluation prompt sentence, such as: “Here is a math question, a model answer, and a student answer. Score the student answer from 0 to 5 and provide a short explanation of the score. Question: Model answer: Student answer:”

Server passes this prompt and the respective texts to the generative AI model, which produces a numerical score and explanatory feedback. Server translates the score into an internal grading scale, logs it, and extracts feedback information. Server may further apply the emotion estimation function to the learner's answer text, and if the emotion state indicates discouragement, server prepares another prompt sentence such as:

“The student appears discouraged. Rewrite the following feedback to be more encouraging, focusing on what the student did well and giving one clear suggestion for improvement.” Server applies the generative AI model to refine the feedback into emotion-adaptive feedback information. Terminal displays the feedback, including the score, the correct answer, and the elaborated explanation.

This architecture provides technical improvements beyond mere automation of human activity. Server uses prompt sentences as structured, machine-readable control signals, stored and managed alongside content metadata and learner state. By encoding task type, difficulty targets, and emotion state in prompt sentences, server allows the generative AI model to produce constrained and reusable outputs, reducing redundant generation and network calls. For instance, server can cache intermediate generative outputs (such as learning-unit summaries or baseline explanations) and apply emotion-specific refinement via additional prompts, rather than regenerating full responses from scratch. This reduces computation time on the generative AI back end and decreases latency for terminal.

Server improves accuracy and personalization of content generation by combining features from multiple internal models. Server uses embeddings from transformer encoders to represent both learning material and learner interactions, and uses these embeddings as features for routing decisions and prompt construction. For example, server computes a vector representation of the learner's knowledge state and selects different prompt templates based on similarity to pre-defined profiles. This vector-based routing, implemented as a nearest-neighbor search or a small neural classifier, enables finer-grained adaptation than fixed rule-based strategies and improves the technical performance of the system in selecting suitable model behavior.

Server uses specific training procedures for the emotion estimation function and, where applicable, for fine-tuning the generative AI model on educational dialogue and assignments. Server may apply supervised learning with cross-entropy loss on labeled emotion datasets, backpropagating errors through transformer layers to adjust weights. Server may also employ data augmentation techniques, such as paraphrasing or synonym replacement, to increase model robustness to varied learner expressions. These training methods allow server to obtain models that perform more reliable emotion detection and pedagogy-appropriate generation, thereby reducing classification errors and inconsistent explanations.

In addition, server organizes all content and interaction data into specific data structures. For example, each learning unit record includes fields for source text, summary information, script information, associated audio and video identifiers, and a set of prompt identifiers used during generation. Each learner record includes learning progress information, emotion state history, and mappings to generated assignments and questions. By storing these associations explicitly, server can compute cross-linked indices and optimize queries for recommendation and analysis, reducing input/output operations and improving throughput of the educational service.

Server further improves communication efficiency between server and terminal by transmitting compact identifiers and metadata references instead of full content whenever possible. Terminal only requests full video or audio streams when playback is required, and otherwise uses JSON metadata to render lists and summaries. This selective transfer reduces bandwidth usage on the communication network and allows more concurrent sessions without degradation.

Alternative embodiments may vary in model architecture and deployment. In one embodiment, server uses an encoder-decoder transformer with around a few hundred million parameters deployed on GPU-equipped machines for low-latency inference. In another embodiment, server uses a smaller distilled model for mobile or edge deployment in order to provide offline or low-bandwidth operation on terminal, with only periodic synchronization to the central server. In yet another embodiment, emotion estimation may be performed on terminal, using a compact classifier to preserve privacy, and only emotion labels are sent to server.

Server may also employ different strategies for prompt sentence management. In one embodiment, server stores parameterized prompt templates in a configuration repository and fills in variables such as subject, grade level, and emotion state at runtime. In another embodiment, server dynamically composes prompts by combining reusable segments, such as task description segments, tone control segments, and formatting instructions, which are selected according to computed learner features. This modular construction of prompt sentences further enhances control over generative outputs and reduces manual configuration effort.

Through the combination of these modules and data flows, the system enables a tightly integrated, technically enhanced pipeline for generating, adapting, and delivering instructional content. Server, terminal, and user cooperate in this architecture, where server performs complex data transformations and model inferences, terminal presents audiovisual content and collects learner input, and user interacts through questions and assignments. The overall effect is an improvement in computational efficiency, accuracy of adaptation, and scalability of AI-assisted learning compared to conventional, loosely coupled or manually configured systems.

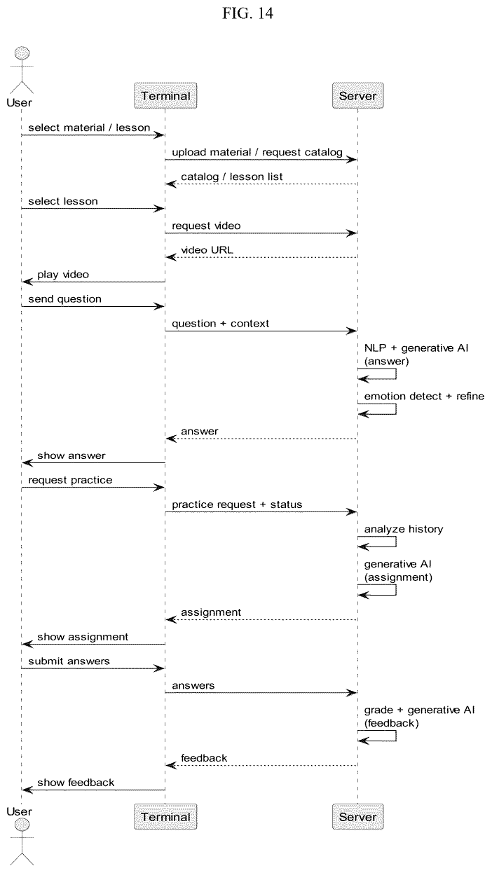

The following describes the processing flow using FIG. 14.

### Step 1:

Server receives learning material from terminal.

Server takes, as input, a digital file or text stream representing learning material (for example, a textbook chapter or lecture notes) uploaded by terminal. Server validates file type and size, and if necessary converts the file to plain text using document parsing software. Server performs data processing to normalize character encoding to UTF-8, remove control characters, and segment the text into paragraphs. Server outputs normalized text data and stores it in a content repository together with metadata such as title, subject, and grade level.

Server segments the learning material into learning units.

Server takes, as input, the normalized text data from Step 1. Server applies a natural language processing function using, for example, a transformer-based encoder to compute token embeddings and detect headings, section boundaries, and topic shifts. Server performs data analysis by clustering sentences based on similarity of embeddings and by recognizing structural markers (such as numbered headings or specific formatting tokens). Server outputs a set of learning unit records, each containing a text span, a tentative title, and position indices, and stores these records in a database.

### Step 3:

Server generates initial summary information using a generative AI model.

Server takes, as input, each learning unit text and associated metadata (for example, desired lesson length and difficulty). Server constructs a prompt sentence such as:

“Summarize the following textbook section into 2-3 concise educational units suitable for a 10-minute lesson each. Output a numbered list with clear, simple explanations.” Server concatenates the prompt sentence and the learning unit text and tokenizes the combined string into input IDs for the generative AI model. Server performs data computation by executing a forward pass through the generative sequence model, calculating attention weights and output token probabilities, and decoding the most likely output sequence. Server outputs summary information in natural language and writes the summaries to the database linked to their corresponding learning units.

### Step 4:

Server refines summaries into spoken-style script information.

Server takes, as input, the summary information produced in Step 3. Server constructs a new prompt sentence such as:

“Rewrite the following educational unit as a friendly spoken explanation for a high-school student. Use short sentences and spoken style.”

Server concatenates the prompt sentence and the summary text, tokenizes the sequence, and feeds it into the generative AI model. Server performs data transformation by decoding the model's output into text with simplified grammar, added discourse markers, and oral-style phrasing. Server outputs script information for oral explanation and stores this script information as a separate field for each learning unit.

### Step 5:

Server converts script information into audio data.

Server takes, as input, the script information from Step 4. Server sends the script text to a text-to-speech engine via an API, specifying parameters such as language code, voice profile, speaking speed, and sampling rate. The text-to-speech engine performs data computation by converting graphemes to phonemes, applying a neural acoustic model and a vocoder to synthesize waveform samples. Server receives the resulting audio stream, encodes it into a compressed format (for example, MP3 or AAC), and stores the audio file in an object storage service. Server outputs audio data identifiers and updates the database with references to the stored audio.

### Step 6:

Server generates virtual character video based on audio data and script information. Server takes, as input, the audio data identifiers and the script information associated with each learning unit. Server calls a virtual character generation engine through an API, sending the audio file URL, the script text, a selected avatar template, and layout options. The virtual character engine performs data operations by extracting timing information (such as phoneme boundaries) from the audio and applying animation curves to a 2D or 3D character rig to synchronize lip movements and gestures with the audio. Server receives, as output, video data (for example, encoded in H.264 video with AAC audio), stores the video file in storage, and records video URLs and metadata in the database.

### Step 7:

Server assembles a lesson catalog for terminal.

Server takes, as input, the database records of learning units, summary information, script information, audio data, and video data. Server aggregates these records by course, chapter, or topic and computes additional metadata such as estimated duration (from audio length), difficulty level (from unit length and vocabulary complexity), and prerequisite relationships. Server performs data aggregation and indexing operations to create a lesson catalog structure containing lists of available lessons and associated identifiers. Server outputs the catalog as a structured response (such as JSON) through an API endpoint.

### Step 8:

Terminal retrieves and displays the lesson catalog.

Terminal takes, as input, user credentials or session information and sends a request to server for the lesson catalog. Terminal receives the catalog data containing lesson titles, thumbnails, durations, and difficulty indicators. Terminal performs data processing by sorting or filtering lessons based on criteria such as subject or progress status, and renders a graphical interface listing the lessons. Terminal outputs a visual display that user can interact with to select a desired learning unit.

### Step 9:

User selects a lesson and initiates playback.

User takes, as input, the list of available lessons shown on terminal and selects a target lesson (for example, by tapping or clicking). User causes terminal to send a request to server containing the selected lesson identifier. Terminal receives from server the corresponding video URL and supplementary data such as captions or related assignments. Terminal outputs a playback control interface and initializes the media player with the given video URL.

### Step 10:

Terminal streams and presents the virtual character video.

Terminal takes, as input, the video URL obtained in Step 9. Terminal opens a streaming connection to the content server, receives compressed video and audio packets, and performs data decoding using a media codec. Terminal renders the video frames on the display and plays the synchronized audio through the audio output hardware. Terminal logs playback events such as start time, pause actions, and current time position, and sends periodic progress updates to server. Terminal outputs audiovisual content to user and telemetry data back to server.

### Step 11:

Server records and updates learning progress information.

Server takes, as input, the playback event data sent from terminal, including timestamps, lesson identifiers, and playback positions. Server updates learning status data for the corresponding learner by computing watch percentages, completion flags, and last-access times. Server performs data aggregation by merging multiple events into consolidated progress metrics. Server outputs updated learning progress information for each learning unit and stores it in the database for future use in personalization and reporting.

### Step 12:

User inputs question text during or after playback.

User takes, as input, the information presented in the virtual character video and forms a question, such as:

“I don't understand why the derivative represents a rate of change.”

User enters this question through an input field on terminal and submits it. Terminal captures the question text and context data (such as current lesson identifier and playback timestamp) as input and sends these data to server. Terminal outputs a message to server representing the question request.

### Step 13:

Server analyzes the question and generates answer information.

Server takes, as input, the question text and context data from Step 12. Server constructs a prompt sentence such as:

“You are a tutor. The student is watching a lesson about basic derivatives. Explain the answer to the following question in a simple way. Use one or two concrete examples.” Server concatenates this prompt sentence with the learner's question and tokenizes the combined text for the generative AI model. Server performs data computation by executing the generative model's forward pass and decoding the output sequence into natural-language answer information. Server may perform post-processing such as trimming incomplete sentences or normalizing punctuation. Server outputs the generated answer information and temporarily stores it in association with the learner and lesson.

### Step 14:

Server estimates the emotion state from question text.

Server takes, as input, the question text from Step 13. Server feeds the text into an emotion estimation model implemented as a classifier neural network. Server performs tokenization, embedding lookup, transformer-encoder computation, and then applies a classification layer to compute probabilities over predefined emotion labels. Server selects the emotion state with the highest probability and may apply thresholds to distinguish strong emotions from neutral states. Server outputs an emotion state label (for example, “confused”) and a confidence score.

### Step 15:

Server refines the answer based on the emotion state.

Server takes, as input, the initial answer information from Step 13 and the emotion state from Step 14. If the emotion state matches a condition that requires adaptation, server constructs an additional prompt sentence, for example:

“The student seems confused. Rewrite the following explanation to be even simpler, with step-by-step reasoning and reassurance, and avoid technical jargon.”

Server concatenates this additional prompt sentence with the initial answer and tokenizes the text. Server performs another generative AI inference to obtain revised explanation text. Server outputs emotion-adaptive explanation information and, if adaptation is not required, uses the initial answer information as the final output.

### Step 16:

Server delivers answer information to terminal and updates history.

Server takes, as input, the final answer text (with or without emotion adaptation). Server encapsulates the answer in a response payload, optionally including structured elements such as bullet lists or follow-up suggestions. Server updates learning history data to record that a question was asked and answered, storing the question text, the answer text, and the emotion state. Server sends the response payload to terminal over a network connection. Server outputs both a transmission to terminal and a persistent record of the interaction in the database.

### Step 17:

Terminal displays the answer and optionally requests spoken or avatar output.

Terminal takes, as input, the answer response from server. Terminal renders the answer text in the user interface, for example as a dialogue bubble or a panel below the video. If configuration or user preference requires spoken playback, terminal sends a request back to server to synthesize the answer as audio or video. Terminal outputs updated UI elements that present the answer to user and any controls for audio or additional playback.

### Step 18:

User requests additional assignments or practice.

User takes, as input, the improved understanding or remaining confusion after reading the answer. User may press a “Practice more” button or type a natural language request such as: “Give me some practice problems on this topic.”

Terminal captures the request text and sends it, along with current learning status data, to server as input. Terminal outputs a practice request message for processing.

### Step 19:

Server analyzes learning history to determine assignment parameters.

Server takes, as input, the practice request and the learning status data for the learner. Server queries the database for learning history data, including previously completed assignments, scores, and topics studied. Server performs data analysis by computing error rates per topic, measuring time spent per unit, and identifying patterns in past questions. Server derives assignment parameters such as number of problems, difficulty range, and focus concepts. Server outputs a concise parameter description that will be used to construct a prompt sentence for assignment generation.

### Step 20:

Server generates personalized assignment information using a generative AI model.

Server takes, as input, the assignment parameters from Step 19. Server formulates a prompt sentence such as:

“Create 5 math problems about basic derivatives for a high-school student. The student understands the derivative formula but is confused about the idea of rate of change. Start with very simple, concrete examples and gradually increase difficulty. Provide correct answers and short hints.”

Server concatenates this prompt sentence with a short summary of the learner's performance profile and tokenizes the combined text. Server executes the generative AI model and decodes the output sequence into a set of problems, corresponding answers, and hints. Server then parses the text output using pattern recognition (for example, numbered lists) into a structured format with question IDs. Server outputs assignment information in a machine-usable structure and stores it in the database.

### Step 21:

Terminal presents the assignment and collects learner responses.

Terminal takes, as input, the assignment information sent by server. Terminal renders each question with appropriate input controls, such as text boxes or multiple-choice options. User reads each question and enters assignment answer text or selects options. After completing all questions, user submits responses. Terminal aggregates the responses into a structured payload, including assignment and question identifiers, and transmits this data to server. Terminal outputs a submission message containing the learner's answers.

### Step 22:

Server evaluates assignment answers and generates feedback.

Server takes, as input, the learner's assignment answers from Step 21 and the corresponding assignment information from Step 20. For objective questions, server compares submitted answers with stored correct answers using exact string comparison or tolerance-based numeric comparison, and assigns scores. For open-ended questions, server constructs an evaluation prompt sentence and passes the question, the model answer, and the learner's answer to the generative AI model. Server obtains a score and explanatory feedback, parses the output into a numeric and textual portion, and aggregates scores across the assignment. Server outputs preliminary feedback information including scores, correctness flags, and explanations.

### Step 23:

Server adapts feedback based on inferred emotion state and updates progress.

Server takes, as input, the learner's answer texts and preliminary feedback information. Server applies the emotion estimation function to the answer texts and, optionally, to free-form comments. If the emotion state indicates discouragement or overconfidence, server constructs a refinement prompt sentence to adjust tone and content of the feedback. Server executes the generative AI model with this refinement prompt and the preliminary feedback to obtain emotion-adaptive feedback information. Server updates learning progress information by recording assignment completion, scores, and revised emotion-aware feedback. Server outputs final feedback information to terminal and persists updated learning progress metrics for use in future adaptations.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naive Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Moreover, although the processing by the data processing system 10 described above was executed by the specific processing unit 290 of the data processing device 12 or by the control unit 46A of the smart device 14, the processing may be executed by a specific processing unit 290 of the data processing device 12 and a control unit 46A of the smart device 14. Moreover, the specific processing unit 290 of the data processing device 12 acquires and collects information needed for processing from the smart device 14 or from an external device or the like, and the smart device 14 acquires and collects information needed for processing from the data processing device 12 or from an external device or the like.

For example, a collection unit is implemented by the control unit 46A of the smart device 14 and/or by the specific processing unit 290 of the data processing device 12. For example, an acquisition unit acquires number-of-steps data using the camera 42 and/or the communication I/F 44 of the smart device 14, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the output device 40 of the smart device 14 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart device 14.

### Second Exemplary Embodiment

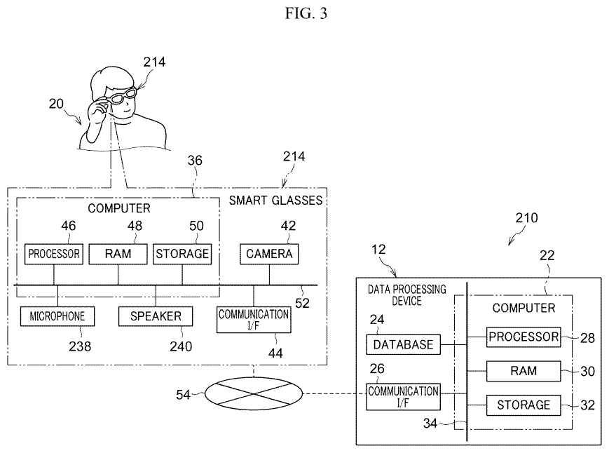

FIG. 3 illustrates an example of a configuration of a data processing system 210 according to a second exemplary embodiment.

As illustrated in FIG. 3, the data processing system 210 includes a data processing device 12 and smart glasses 214. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart glasses 214 include a computer 36, a microphone 238, a speaker 240, a camera 42, and a communication I/F 44. The computer 36 includes a processor 46, RAM 48, and storage 50. The processor 46, the RAM 48, and the storage 50 are connected to a bus 52. The microphone 238, the speaker 240, the camera 42, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

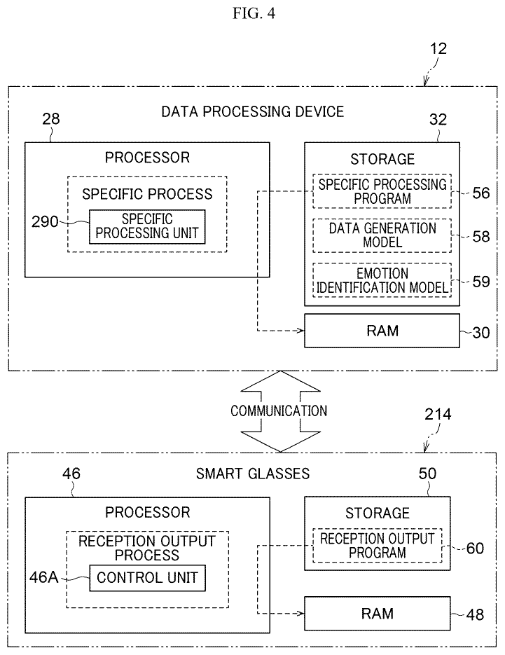

FIG. 4 illustrates an example of relevant functions of the data processing device 12 and the smart glasses 214. As illustrated in FIG. 4, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart glasses 214. A reception and output program 60 is stored in the storage 50. The processor 46 reads the reception and output program 60 from the storage 50 and in the RAM 48 executes the read reception and output program 60. The reception and output processing is implemented by the processor 46 operating as the control unit 46A according to the reception and output program 60 executed in the RAM 48. Note that a configuration may be adopted in which the smart glasses 214 include a data generation model and an emotion identification model similar to the data generation model 58 and the emotion identification model 59, and processing similar to the specific processing unit 290 is performed using these models.

Next, description follows regarding the specific processing by the specific processing unit 290 of the data processing device 12. The units of the system described below are implemented by the data processing device 12 and the smart glasses 214. In the following description the data processing device 12 is called a “server”, and the smart glasses 214 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the smart glasses 214. The control unit 46A in the smart glasses 214 outputs the specific processing result to the speaker 240. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative Als such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the smart glasses 214, the processing may be executed by a specific processing unit 290 of the data processing device 12 and a control unit 46A of the smart glasses 214. Moreover, the specific processing unit 290 of the data processing device 12 acquires and collects information needed for processing from the smart glasses 214 or from an external device or the like, and the smart glasses 214 acquires and collects information needed for processing from the data processing device 12 or from an external device or the like.

For example, the collection unit is implemented by the control unit 46A of the smart glasses 214 and/or by the specific processing unit 290 of the data processing device 12. For example, an acquisition unit acquires number-of-steps data using the camera 42 and/or the communication I/F 44 of the smart glasses 214, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 of the smart glasses 214 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart glasses 214.

### Third Exemplary Embodiment

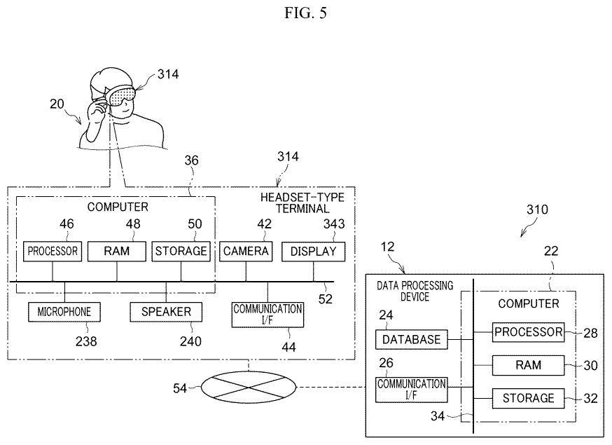

FIG. 5 illustrates an example of a configuration of a data processing system 310 according to a third exemplary embodiment.

As illustrated in FIG. 5, the data processing system 310 includes a data processing device 12 and a headset-type terminal 314. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The headset-type terminal 314 includes a computer 36, a microphone 238, a speaker 240, a camera 42, a communication I/F 44, and a display 343. The computer 36 includes a processor 46, RAM 48, and storage 50. The processor 46, the RAM 48, and the storage 50 are connected to a bus 52. The microphone 238, the speaker 240, the camera 42, the display 343, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

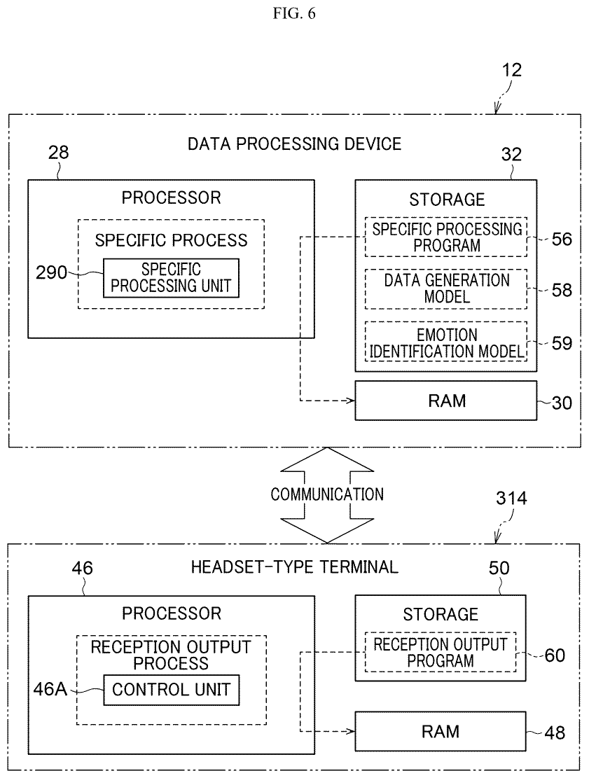

FIG. 6 illustrates an example of relevant functions of the data processing device 12 and the headset-type terminal 314. As illustrated in FIG. 6, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the headset-type terminal 314. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the headset-type terminal 314. In the following description the data processing device 12 is called a “server”, and the headset-type terminal 314 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the headset-type terminal 314. In the headset-type terminal 314, the control unit 46A outputs the result of the specific processing to the speaker 240 and the display 343. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the headset-type terminal 314, the processing may be executed by a specific processing unit 290 of the data processing device 12 and a control unit 46A of the headset-type terminal 314. Moreover, the specific processing unit 290 of the data processing device 12 acquires and collects information needed for processing from the headset-type terminal 314 or from an external device or the like, and the headset-type terminal 314 acquires and collects information needed for processing from the data processing device 12 or from an external device or the like.

For example, the collection unit is implemented by the control unit 46A of the headset-type terminal 314 and/or by the specific processing unit 290 of the data processing device 12. For example, an acquisition unit acquires number-of-steps data using the camera 42 and/or the communication I/F 44 of the headset-type terminal 314, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the display 343 of the headset-type terminal 314 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the headset-type terminal 314.

### Fourth Exemplary Embodiment

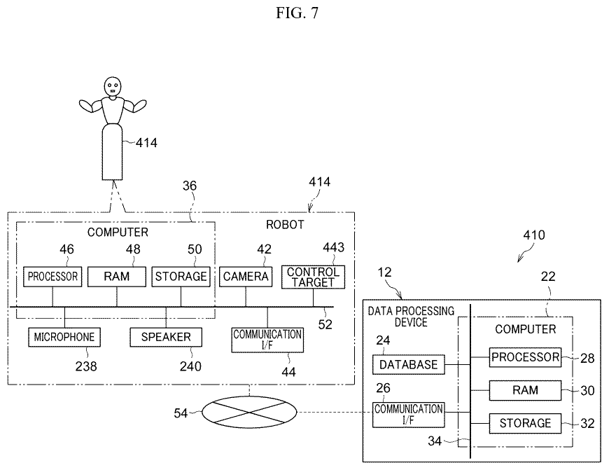

FIG. 7 illustrates an example of a configuration of a data processing system 410 according to a fourth exemplary embodiment

As illustrated in FIG. 7, the data processing system 410 includes a data processing device 12 and a robot 414. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The robot 414 includes a computer 36, a microphone 238, a speaker 240, a camera 42, a communication I/F 44, and a control target 443. The computer 36 includes a processor 46, RAM 48, and storage 50. The processor 46, the RAM 48, and the storage 50 are connected to a bus 52. The microphone 238, the speaker 240, the camera 42, the control target 443, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the robot 414 (for example, with an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

The control target 443 includes a display device, eye LEDs, and motors to drive arms, hands, feet, and the like. The posture and gesture of the robot 414 are controlled by controlling the motors of the arms, hands, feet, and the like. Part of an emotion of the robot 414 can be expressed by controlling these motors. Moreover, a facial expression of the robot 414 can be represented by controlling an illumination state of the eye LEDs of the robot 414.

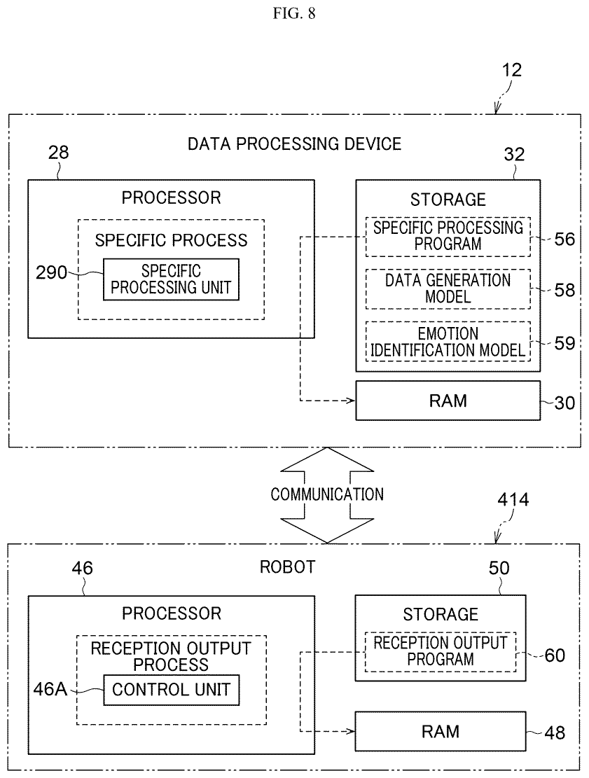

FIG. 8 illustrates an example of relevant functions of the data processing device 12 and the robot 414. As illustrated in FIG. 8, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the robot 414. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the robot 414. In the following description the data processing device 12 is called a “server”, and the robot 414 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the robot 414. In the robot 414, the control unit 46A outputs the result of the specific processing to the speaker 240 and the control target 443. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the robot 414, the processing may be executed by a specific processing unit 290 of the data processing device 12 and a control unit 46A of the robot 414. Moreover, the specific processing unit 290 of the data processing device 12 acquires and collects information needed for processing from the robot 414 or from an external device or the like, and the robot 414 acquires and collects information needed for processing from the data processing device 12 or from an external device or the like.

For example, the collection unit is implemented by the control unit 46A of the robot 414 and/or by the specific processing unit 290 of the data processing device 12. For example, an acquisition unit acquires number-of-steps data using the camera 42 and/or the communication I/F 44 of the robot 414, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the control target 443 of the robot 414 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the robot 414.

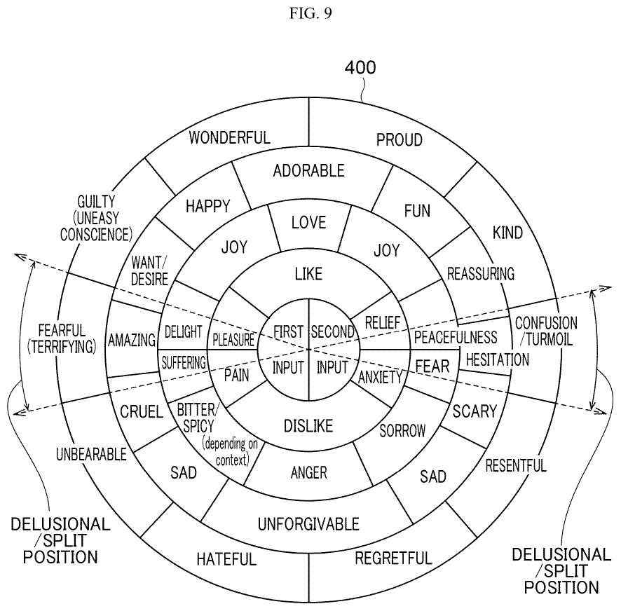

Note that the emotion identification model 59 serves as an emotion engine, and may decide the emotion of a user according to a specific mapping. Specifically, the emotion identification model 59 may decide the emotion of a user according to an emotion map (see FIG. 9) that is a specific mapping. Moreover, the emotion identification model 59 may also decide the emotion of the robot similarly, and the specific processing unit 290 may be configured so as to perform the specific processing using the emotion of the robot.

FIG. 9 is a diagram illustrating an emotion map 400 mapping plural emotions. In the emotion map 400, emotions are arranged in concentric circles that radiate out from the center. Primitive states of emotion are arranged nearer to the center of the concentric circles. Emotions expressing states and actions generated from states of mind are arranged further toward the outside of the concentric circles. Emotions are defined as including both affect and mental states. Emotions generated from reactions occurring in the brain are generally arranged at the left side of the concentric circles. Emotions induced by situational assessment are generally arranged at the right side of the concentric circles. Emotions generated from reactions occurring in the brain that are also emotions induced by situational assessment are generally arranged toward the top and toward the bottom of the concentric circles. Moreover, emotions of “euphoria” are arranged at the upper side of the concentric circles, and emotions of “dysphoria” are arranged at the lower side of the concentric circles. Plural emotions are accordingly mapped in this manner in the emotion map 400 based on a structure giving rise to emotions, and emotions that readily occur at the same time are mapped close to each other.

An example of such emotions is a distribution of emotions in the direction of 3 o'clock on the emotion map 400, generally around a boundary between relief and anxiety. Situational awareness dominates over internal sensations in the right half of the emotion map 400, with an impression of calm.

The inside of the emotion map 400 represents feelings, and the outside of the emotion map 400 represents actions, and so emotions further toward the outside of the emotion map 400 are more visible (are expressed by actions).

Human emotions are based on various balances, such as posture and blood sugar value balances, with a state of dysphoria being exhibited when these balances are far from ideal and a state of euphoria being exhibited when these balances are near to ideal. Even in a robot, a car, a motorbike, or the like, emotions can be thought of as being based on various balances such as orientation and remaining battery balances, with a state called dysphoria being exhibited when these balances are far from ideal and a state called euphoria being exhibited when these balances are near to ideal. An emotion map may, for example, be generated based on the emotion map of Dr. Mitsuyoshi (PhD Dissertation https://ci.nii.ac.jp/naid/500000375379: “Research on the phonetic recognition of feelings and a system for emotional physiological brain signal analysis”, Tokushima University). Emotions belonging to an area called “reaction” where feeling dominates are arranged in the left half of the emotion map. Moreover, emotions belonging to an area called “situation” where situational awareness dominates are arranged in the right half of the emotion map.

There are two types of emotion that facilitate leaning in an emotion map. One is an emotion in the vicinity of the center of negative “penitence” and “reflection” on the situational side. In other words, sometimes a negative “emotion” such as “I don't want to feel this way ever again” and “I don't want to be chided again” is experienced in a robot. Another is a positive emotion in the area of “desire” on the reaction side. In other words, there are times when a positive feeling such as “desire more” and “want to know more” is experienced.

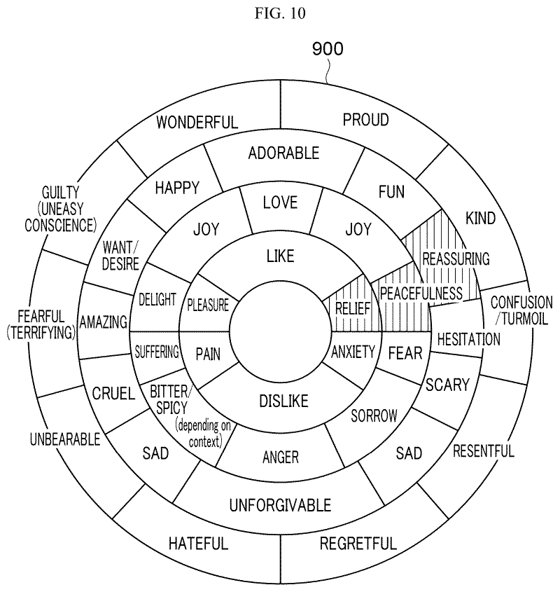

In the emotion identification model 59, user input is input to a pre-trained neural network, and emotion values indicating emotions shown on the emotion map 400 are acquired and the emotions of the user are decided. This neural network is pre-trained based on plural training data sets that each combine a user input with an emotion value indicating an emotion shown on the emotion map 400. The neural network is also trained such that emotions arranged close to each other have values that are close to each other, as in an emotion map 900 illustrated in FIG. 10. In FIG. 10 the plural emotions of “relief”, “peaceful”, and “reassured” are indicated as an example of close emotion values.

Although the system according to the present disclosure has been described mainly as functions of the data processing device 12, the system according to the present disclosure is not limited to being implemented in a server. The system according to the present disclosure may be implemented as a general information processing system. The present disclosure may, for example, be implemented by a software program operating on a personal computer, and may be implemented by an application operating on a smartphone or the like. The method according to the present disclosure may also be supplied to a user in the form of Software as a Service (SaaS).

Although in the exemplary embodiments described above examples are given of embodiments in which the specific processing is performed by a single computer 22, technology disclosed herein is not limited thereto, and distributed processing may be performed for the specific processing, with the specific processing distributed across plural computers including the computer 22. For example, the data generation model 58 may be provided in a device external to the data processing device 12, such that data generation in response to input data is performed in the external device.

Although in the exemplary embodiments described above examples are described of embodiments in which the specific processing program 56 is stored in the storage 32, the technology disclosed herein is not limited thereto. For example, the specific processing program 56 may be stored on a portable, non-transitory, computer readable, storage medium, such as universal serial bus (USB) memory or the like. The specific processing program 56 stored on the non-transitory storage medium is then installed on the computer 22 of the data processing device 12. The processor 28 then executes the specific processing according to the specific processing program 56.

Moreover, the specific processing program 56 may be stored on a storage device, such as a server connected to the data processing device 12 over the network 54, with the specific processing program 56 then being downloaded in response to a request from the data processing device 12 and installed on the computer 22.

Note that there is no need to store the entire specific processing program 56 on the storage device, such as a server connected to the data processing device 12 over the network 54, or to store the entire specific processing program 56 on the storage 32, and part of the specific processing program 56 may be stored thereon.

Hardware resources for executing the specific processing may use various processors as listed below. Examples of processors include, for example, a CPU that is a general-purpose processor that functions as a hardware resource to execute the specific processing by executing software, namely a program. Moreover, the processor may, for example, be a dedicated electronic circuit that is a processor having a circuit configuration custom designed for executing the specific processing, such as a field-programmable gate array (FPGA), a programmable logic device (PLD), or an application specific integrated circuit (ASIC). Memory is inbuilt or connected to each of these processors, and the specific processing is executed by each of these processors using the memory.

The hardware resource that executes the specific processing may be configured from one of these various processors, or may be configured from a combination of two or more processors of the same or different type (for example, a combination of plural FPGAs, or a combination of a CPU and a FPGA). The hardware resource executing the specific processing may be a single processor.

Examples of configurations of a single processor include, firstly, a configuration of a single processor resulting from combining one or more CPU and software, in an embodiment in which this processor functions as the hardware resource for executing the specific processing. Secondly, as typified by a System-on-chip (SOC) or the like, there is also an embodiment that uses a processor realized by a single IC chip to function as an overall system including plural hardware resources for executing the specific processing. Adopting such an approach means that the specific processing is realized using one or more of the various processors described above as hardware resource.

Furthermore, more specifically, an electrical circuit that combines circuit elements such as semiconductor elements or the like may be employed as a hardware structure of these various processors. The specific processing is merely an example thereof. This means that obviously redundant steps may be omitted, new steps may be added, and the processing sequence may be swapped around within a range not departing from the spirit of the present disclosure.

The described content and drawing content illustrated above are a detailed description of parts according to the present disclosure, and are merely examples of the present disclosure. For example, description related to the above configuration, function, operation, and advantageous effects is a description related to examples of the configuration, function, operation, and advantageous effects of parts according to the present disclosure. This means that obviously redundant parts may be eliminated, new elements may be added, and switching around may be performed on the described content and drawing content illustrated above within a range not departing from the spirit of the present disclosure. Moreover, to avoid misunderstanding and to facilitate understanding of parts according to the present disclosure, description related to common knowledge in the art and the like not particularly needing description to enable implementation of the present disclosure is omitted in the described content and drawing content illustrated as described above.

All publications, patent applications and technical standards mentioned in the present specification are incorporated by reference in the present specification to the same extent as if each individual publication, patent application, or technical standard was specifically and individually indicated to be incorporated by reference.

Note that, regarding the above description, the following supplementary notes are further disclosed.

### Example 1

### (Supplementary 1)

A system comprising a processor,
wherein the processor is configured to
receive document data and a prompt sentence from a terminal, convert the document data and the prompt sentence into structured data, and store the structured data, and preprocess the document data and the prompt sentence included in the structured data to convert them into token sequences, and generate an input sequence for operating a natural language processing engine and a generative AI model based on the token sequences, and apply the natural language processing engine to the input sequence to extract high-importance information from the document data, and specify summarization target information based on the extracted high-importance information, and
provide an input sequence including the summarization target information and the prompt sentence to the generative AI model as a prompt sentence, and cause the generative AI model to generate summary text segmented in educational time units, and
provide, to the generative AI model as a prompt sentence, an input sequence including question content from a learner and at least one of the document data and the summary text, and cause the generative AI model to generate response text corresponding to the question content, and
provide, to the generative AI model as a prompt sentence, the document data and a prompt sentence relating to a learning objective, and cause the generative AI model to generate evaluation assignment data based on the document data, and
receive answer data for the evaluation assignment data from the learner, and generate automatic scoring data and evaluation result data based on the evaluation assignment data and the answer data, and
generate feedback information based on the evaluation result data and learner state information, and transmit the summary text, the response text, the evaluation assignment data, and the feedback information to the terminal.

### (Supplementary 2)

The system according to supplementary 1,
wherein the processor is configured to
provide, to the generative AI model as the prompt sentence when summarizing the document data, a prompt sentence that instructs understanding of the document data and presentation in educational time units, and generate, based on the prompt sentence and the summarization target information, a plurality of pieces of summary text in which the document data is divided for each predetermined time unit.

### (Supplementary 3)

The system according to supplementary 1,
wherein the processor is configured to
provide, to the generative AI model as the prompt sentence when generating the response text to the question content from the learner, a prompt sentence including the question content, at least one of the summary text and the document data related to the question content, and information indicating an education level, and generate, based on the prompt sentence, the response text including an explanation adapted to the education level.

### Application Example 1

### (Supplementary 1)

A system comprising a processor,
wherein the processor is configured to
acquire educational information from a storage unit, analyze the educational information, divide the educational information into instructional units corresponding to class periods, and generate text data for each instructional unit,
construct a prompt sentence, for each instructional unit, based on the text data for the instructional unit and learning theme information, the prompt sentence instructing a generative AI model to generate a summary of the text data, and provide input data including the prompt sentence to the generative AI model so as to cause the generative AI model to generate summary text data for each instructional unit,
store the generated summary text data in the storage unit in association with the corresponding instructional unit, and assign index information to the summary text data in a form searchable on an instructional-unit basis,
receive, from a user information processing terminal, a request signal, identify an instructional unit designated by the user information processing terminal based on the request signal, and distribute to the user information processing terminal the summary text data associated with the identified instructional unit,
control display on the user information processing terminal so that the distributed summary text data is displayed on a screen of the user information processing terminal, and, in response to a selection operation by a user for another instructional unit, cause the user information processing terminal to acquire and display summary text data corresponding to the other instructional unit,
analyze contents of the educational information using a natural language processing engine, extract important information from the educational information, and generate summary text data of the educational information,
provide to the generative AI model a prompt sentence instructing understanding of the educational information and a prompt sentence instructing understanding of question content, and cause the generative AI model to generate answer text data to questions from a learner based on the prompt sentence, and
analyze an emotion of the learner based on learner state information, generate feedback information according to an analysis result of the emotion, and output the feedback information to the user information processing terminal.

### (Supplementary 2)

The system according to supplementary 1,
wherein the processor is configured to
provide, when summarizing the educational information, a prompt sentence instructing understanding of the educational information and generation of summaries for each instructional unit to the generative AI model, and cause the generative AI model to generate the summary text data for each instructional unit based on the prompt sentence.

### (Supplementary 3)

The system according to supplementary 1,
wherein the processor is configured to
provide, when generating the answer text data to the questions from the learner, a prompt sentence instructing understanding of the question content and association with the educational information to the generative AI model, and cause the generative AI model to generate the answer text data based on the prompt sentence.

### Example 2

### (Supplementary 1)

A system comprising a processor,
wherein the processor is configured to
analyze content of an educational information medium by using a natural language processing function, extract important information from the content for each educational unit, and generate summary information, and
provide a generative AI model with a prompt sentence including the summary information or educational text information as input, and generate narration text information for learners or question-answer text information based on the generative AI model, and
convert the narration text information into audio data by using a speech synthesis function, and generate an audio file while controlling a speaker attribute or a speaking style, and generate a virtual character video by using a virtual character generation function, the virtual character video having lip-sync motion and facial motion synchronized with the audio data, and generate educational video data by combining the virtual character video with background video or explanatory text information, and
encode the educational video data in a plurality of image qualities or bit rates, convert the encoded data into a distribution data format, store the converted data, and make the converted data streamable to a learner terminal via a network, and
dynamically generate a prompt sentence for the generative AI model based on a question sentence acquired from a learner and content of the related educational information medium, generate answer text information for the question based on the prompt sentence, and, when necessary, generate answer educational video data by using the speech synthesis function and the virtual character generation function, and
acquire emotion information of the learner by using an emotion analysis function that estimates an emotional state of the learner, and change a representation style of the prompt sentence provided to the generative AI model or feedback content according to the emotion information.

### (Supplementary 2)

The system according to supplementary 1,
wherein the processor is configured to
provide the generative AI model with a prompt sentence that instructs understanding of the content of the educational information medium and division of the content into educational units when summarizing the content of the educational information medium, and generate, based on the prompt sentence, summary information and narration text information having a length and a difficulty level suitable for a learner's level of understanding and learning time.

### (Supplementary 3)

The system according to supplementary 1,
wherein the processor is configured to
provide the generative AI model, when generating an answer to a question from a learner, with a prompt sentence including the question sentence and content of the related educational information medium, the prompt sentence instructing performance of an easy-to-understand explanation as a teacher role and inclusion of a concrete example, generate answer text information based on the prompt sentence, convert the answer text information into audio data and a virtual character video, and distribute the converted data as answer educational video data to the learner terminal.

### Application Example 2

### (Supplementary 1)

A system comprising a processor,
wherein the processor is configured to
analyze text information of learning material by using a natural language processing function, extract important information from the text information, and generate summary information for each learning unit;
provide a generative AI model with input data including a prompt sentence that instructs the generative AI model to understand contents of the learning material and to structure the contents into the learning units, and cause the generative AI model to generate, as output, the summary information and script information for oral explanation;
convert the script information for oral explanation into audio data by using a speech synthesis function;
generate video data in which a virtual character performs an explanation, by using a virtual character generation function on the basis of the audio data and the script information for oral explanation, and distribute the video data to a terminal device via a communication network; acquire question text of a learner and learning status data from the terminal device, provide the generative AI model with input data including a prompt sentence that instructs the generative AI model to generate an answer and an assignment on the basis of the question text and the learning status data, and cause the generative AI model to generate, as output, answer information to the question and assignment information individualized for the learner; estimate an emotion state of the learner from at least one of the question text, assignment answer text, and learning history data by using an emotion estimation function, generate an additional prompt sentence for modifying at least one of the answer information, the assignment information, and feedback information in accordance with the emotion state, provide the generative AI model with the additional prompt sentence, and cause the generative AI model to generate emotion-adaptive explanation information or feedback information; and
transmit the answer information, the assignment information, and the emotion-adaptive feedback information to the terminal device, and record and update learning progress information.

### (Supplementary 2)

The system according to supplementary 1,
wherein the processor is configured to provide the generative AI model with the prompt sentence including segment information of the learning material and metadata indicating target understanding levels for the respective learning units, and to instruct the generative AI model to generate the summary information and the script information for oral explanation having difficulty and structure adapted to the metadata.

### (Supplementary 3)

The system according to supplementary 1,
wherein the processor is configured to provide the generative AI model with the prompt sentence including contents of the learner's question, learning history information, and the estimated emotion state, and to instruct the generative AI model to generate the answer information and the assignment information that are personalized on the basis of the learning history information and that have an explanation style adapted to the emotion state.

What is claimed is:

1. A system comprising:
circuitry configured to:
receive, from a terminal device via a packet-switched network, document data and an instruction dataset, convert the document data and the instruction dataset into structured data, and store the structured data in a storage device;
preprocess the document data and the instruction dataset included in the structured data to convert them into token sequences, and generate an input sequence for a natural language processing engine and a generative neural network model based on the token sequences;
apply the natural language processing engine to the input sequence to extract high-importance information from the document data, and specify target information based on the extracted high-importance information;
provide an input sequence including the target information and the instruction dataset to the generative neural network model, and cause the generative neural network model to generate condensed output data segmented into predetermined temporal segments;
provide, to the generative neural network model, an input sequence including query data received from the terminal device via the packet-switched network and at least one of the document data or the condensed output data, and cause the generative neural network model to generate response data corresponding to the query data;
generate evaluation data based on the document data by providing the document data and an objective specification to the generative neural network model, receive answer data from the terminal device, and generate scoring data and result data based on the evaluation data and the answer data; and
generate feedback data based on the result data and user state information, and transmit the condensed output data, the response data, the evaluation data, and the feedback data to the terminal device via the packet-switched network.

2. The system according to claim 1, wherein the circuitry is configured to provide, to the generative neural network model when generating the condensed output data, an instruction that specifies comprehension of the document data and presentation in the predetermined temporal segments, and generate, based on the instruction and the target information, a plurality of condensed output segments in which the document data is divided for each predetermined temporal segment.

3. The system according to claim 2, wherein the circuitry is configured to provide, to the generative neural network model when generating the response data, an input sequence including the query data, at least one of the condensed output data or a portion of the document data related to the query data, and a parameter indicating a complexity level, and generate the response data including an explanation adapted to the complexity level.

4. The system according to claim 3, wherein the circuitry is configured to analyze the document data using the natural language processing engine to identify topic boundaries in the document data, and segment the document data into a plurality of instructional units each corresponding to a respective one of the predetermined temporal segments.

5. The system according to claim 4, wherein the circuitry is configured to store the condensed output data in the storage device in association with corresponding instructional units, and assign index information to the condensed output data in a form searchable on an instructional-unit basis.

6. The system according to claim 5, wherein the circuitry is configured to receive, from the terminal device via the packet-switched network, a request signal designating a particular instructional unit, identify the designated instructional unit, and transmit the condensed output data associated with the identified instructional unit to the terminal device.

7. The system according to claim 1, wherein the natural language processing engine is configured to perform tokenization, part-of-speech tagging, and semantic analysis on the document data to identify sentences and phrases having a relevance score exceeding a predetermined threshold, and designate the identified sentences and phrases as the high-importance information.

8. The system according to claim 7, wherein the circuitry is configured to compute a term-frequency inverse-document-frequency value for each token in the token sequences and rank the tokens by the computed value to identify the high-importance information.

9. The system according to claim 8, wherein the generative neural network model comprises a transformer architecture including an embedding layer, a plurality of self-attention layers, and an output layer configured to produce a probability distribution over a token vocabulary.

10. The system according to claim 9, wherein the circuitry is configured to set inference parameters for the generative neural network model including a temperature value, a sampling threshold, and a maximum output token count so as to control diversity and length of the condensed output data and the response data.

11. The system according to claim 1, wherein the circuitry is configured to generate the evaluation data by providing, to the generative neural network model, an input sequence including the document data and an instruction specifying generation of assessment items covering key concepts identified in the high-importance information, and cause the generative neural network model to output assessment item data including questions and corresponding reference answers.

12. The system according to claim 11, wherein the circuitry is configured to compare the answer data received from the terminal device against the reference answers using a text similarity measure, and assign a score to each answer based on a degree of correspondence.

13. The system according to claim 12, wherein the circuitry is configured to generate the feedback data by selecting, based on the result data, at least one of a corrective explanation, a supplemental reference to a portion of the document data, or a suggestion for review of a specific instructional unit.

14. The system according to claim 1, wherein the circuitry is configured to convert narration text data generated by the generative neural network model into audio data by using a speech synthesis function, and generate an audio output while controlling at least one of a speaker attribute or a speaking style parameter.

15. The system according to claim 14, wherein the circuitry is configured to generate a virtual character video by using a character generation function, the virtual character video having lip-synchronization motion synchronized with the audio data, and combine the virtual character video with supplemental visual data to produce composite output data.

16. The system according to claim 15, wherein the circuitry is configured to encode the composite output data in a plurality of quality levels, convert the encoded data into a streaming distribution format, store the converted data, and make the converted data available to the terminal device via the packet-switched network.

17. The system according to claim 1, wherein the circuitry is configured to acquire user state information including at least one of behavioral data or biometric data from the terminal device via the packet-switched network, apply an emotion analysis model to the user state information to estimate an emotional condition of a user, and adjust at least one of a representation style of a prompt sentence provided to the generative neural network model or content of the feedback data according to the estimated emotional condition.

18. A system comprising:
circuitry configured to:
receive, from a terminal device via a packet-switched network, document data and an instruction dataset, and convert the document data and the instruction dataset into structured data including token sequences;
apply a natural language processing engine to the token sequences to extract high-importance information from the document data by performing tokenization, part-of-speech analysis, and relevance scoring, and specify target information based on the extracted high-importance information;
provide an input sequence including the target information and the instruction dataset to a generative neural network model comprising a transformer architecture with self-attention layers, and cause the generative neural network model to generate condensed output data segmented into predetermined temporal segments;
provide, to the generative neural network model, an input sequence including query data received from the terminal device via the packet-switched network and at least one of the document data or the condensed output data, and cause the generative neural network model to generate response data corresponding to the query data;
generate evaluation data by providing the document data and an objective specification to the generative neural network model, receive answer data from the terminal device, compare the answer data against reference answers using a text similarity measure, and generate scoring data;
acquire user state information from the terminal device, apply an emotion analysis model to the user state information to estimate an emotional condition, and generate feedback data adjusted according to the estimated emotional condition; and
transmit the condensed output data, the response data, the evaluation data, the scoring data, and the feedback data to the terminal device via the packet-switched network.

19. The system according to claim 18, wherein the circuitry is configured to store the condensed output data in a storage device in association with instructional unit identifiers, and in response to a request from the terminal device specifying a particular instructional unit, retrieve and transmit the condensed output data associated with the specified instructional unit.

20. A method comprising:
receiving, by circuitry from a terminal device via a packet-switched network, document data and an instruction dataset, converting the document data and the instruction dataset into structured data, and storing the structured data in a storage device;
preprocessing the document data and the instruction dataset included in the structured data to convert them into token sequences, and generating an input sequence for a natural language processing engine and a generative neural network model based on the token sequences;
applying the natural language processing engine to the input sequence to extract high-importance information from the document data, and specifying target information based on the extracted high-importance information;
providing an input sequence including the target information and the instruction dataset to the generative neural network model, and causing the generative neural network model to generate condensed output data segmented into predetermined temporal segments;
providing, to the generative neural network model, an input sequence including query data received from the terminal device via the packet-switched network and at least one of the document data or the condensed output data, and causing the generative neural network model to generate response data corresponding to the query data;
generating evaluation data based on the document data by providing the document data and an objective specification to the generative neural network model, receiving answer data from the terminal device, and generating scoring data and result data based on the evaluation data and the answer data; and
generating feedback data based on the result data and user state information, and transmitting the condensed output data, the response data, the evaluation data, and the feedback data to the terminal device via the packet-switched network.
